(19) United States
(12) Patent Application Publication
(10) Pub. No.: US 2024/0081371 A1
(43) Pub. Date: Mar. 14, 2024

(54) A PROCESS FOR PREPARING A VEGAN EDIBLE PRODUCT FROM EDIBLE NON-ANIMAL PROTEINS

(71) Applicant: BK GIULINI GMBH, Ladenburg (DE)

(72) Inventors: Wolfgang SCHNEIDER, Mannheim (DE); Alexander GRABER, Mannheim (DE); Andreas HEYL, Neustadt/Weinstrasse (DE); Radovan SPORKA, Heidelberg (DE); Lena-Marie RÄNGER, Ulm (DE); Thomas GRÜTZNER, Ulm (DE)

(21) Appl. No.: 18/274,907

(22) PCT Filed: Feb. 9, 2022
(86) PCT No.: PCT/EP2022/053066

§ 371 Date: Jul. 28, 2023

(30) Foreign Application Priority Data
Feb. 10, 2021 (EP) 21156346.5

(51) Int. Cl. A23J 3/22; A23J 3/14; A23J 3/28; A23L 29/00; A23L 29/256

(52) U.S. Cl. CPC A23J 3/227; A23J 3/14; A23J 3/28; A23L 29/015; A23L 29/035; A23L 29/256

(57) ABSTRACT

The present invention relates to a process for preparing an edible product, in particular a vegan edible product from edible non-animal proteins which comprises the following steps i. to iv.: i. providing a malleable mass containing a) the edible protein component a), which is selected from the group consisting of edible vegetable protein materials, edible microbial protein materials and mixtures thereof; b) an edible fat or oil, hereinafter referred to as component b); c) a water-soluble organic polymeric gelling agent which is capable of being gelled by calcium ions, which is a water-soluble polysaccharide bearing carboxyl groups or a water soluble salt thereof, such as alginate or a pectin, in particular an alginate salt, especially sodium alginate, which is hereinafter referred to as component c); d) a calcium salt being present in retarded form which releases its calcium ions to the mass in a delayed manner, hereinafter referred to as component d) and; e) water, hereinafter referred to as component e); ii. comminuting the malleable mass into particles and bringing the particles into contact with an aqueous solution of a calcium salt to achieve a hardening of the particle surface, where during step ii. conditions are applied which effect the release of the calcium ions from the retarded form of the calcium salt; iii. separating the aqueous solution from the particles, and; iv. subsequently allowing the particles to harden to achieve their final hardness. The thus obtained edible products are suitable for preparing artificial meat products, in particular for vegan artificial meat products.

A process for preparing a vegan edible product from edible non-animal proteins

The present invention relates to a process for preparing a vegan edible product from edible non-animal proteins which comprises
i. providing a malleable mass containing the vegetable and/or microbial protein material, a water-soluble gelling agent, which is capable of being gelled by calcium ions, an edible fat or oil and water,
ii. comminuting the malleable mass into particles and bringing the particles into contact with an aqueous solution of a calcium salt to achieve a hardening of the particles.

The thus obtained edible products are suitable for preparing vegan artificial meat products.

As a basic principle, the main challenge of meat replacement is based on the fact that, with the exception of fibrous muscle meat, which in its smallest units is predominantly composed of linear protein chains, there is no other protein that naturally forms such fibres.

It is principally known in the art to produce artificial meat products from protein materials by a process, which comprises
(1) emulsifying the protein material in the presence of a water-soluble gelling agent, which is capable of being gelled by calcium ions, typically a polysaccharide bearing carboxyl groups, such as alginate or pectin, with water and an oil or fat to obtain a viscous emulsion of the protein and the gelling agent;
(2) comminuting or forming the resultant emulsion into particles, and simultaneously bringing the particles in contact with an aqueous solution of a bivalent metal salt, such as a water-soluble calcium salt, e.g. by soaking the particles in the aqueous solution of a bivalent metal salt.

Due to the hydration of the protein and the gelling agent, the emulsion obtained in step (1) is a dough-like, malleable mass that can be comminuted and formed into particles having the desired shape. Comminution is carried out in the presence of a bivalent metal salt, in particular a calcium salt, which diffuses into the thus formed particles. Thereby, it causes a crosslinking of the gelling agent and a precipitation/gelling of the protein/gelling agent mixture resulting in a hardening of the shaped mass. The obtained mass can be further processed to artificial meat products.

Such a process is disclosed, for example, in EP 174192 A2, where a mass made of casein, an acidic polysaccharide and water is treated at an elevated temperature, followed by shaping the mass and soaking the mass in an aqueous solution of a multivalent metal salt. Modifications of said process, which cope with the specific requirements of the used milk protein, are described in WO 03/061400 and EP 1588626. As all these processes start from milk proteins, the final food products made therefrom could only be classified as vegetarian but not vegan.

NL 1008364 discloses the preparation of an artificial meat product containing no animal proteins comprises the following steps:
(a) preparation of a mixture of a non-animal protein, a plant-derived thickener capable of being precipitated/gelled with bivalent metal salts, such as pectin and alginate, and water;
(b) intensive stirring of the mixture at 40-90° C. to form an emulsion;
(c) mixing the emulsion with a salt solution containing a calcium and/or magnesium salt, to form a fibrous product, which is then further processed.

In this process, the fibre formation is controlled by the stirring speed when mixing the emulsion with salt solution. While the product obtained by this process can be classified as vegan, fibre formation is difficult to control and results in non-uniform fibre formation. Thus, the product quality may vary strongly. Moreover, only emulsions with low protein content were processed and thus, the process resulted in products having a low dry matter content and a low protein content. The product must therefore be pressed in order to increase the dry matter content.

EP 1790233 discloses a process for the preparation of an artificial meat product, where a protein and a fat are emulsified in water followed by subsequently incorporating a thickener, such as alginate, and a precipitant, such as calcium chloride into the emulsion. However, this process does not allow for precisely controlling the fibre structure, since the precipitation takes place very abruptly. Moreover, only small protein concentrations can be handled and thus a further separation step for removing the water from the precipitated emulsion is required.

WO 2014/111103 discloses a process for producing a meat substitute product, which comprises providing an emulsion of a mixture of an edible protein, such as caseinate or a plant protein, alginate, methyl cellulose, an oil and water, and precipitation of the emulsion by adding a combination of CaCl₂) and micellar casein. The amount of added CaCl₂) is chosen such that it alone is not sufficient to bring about complete precipitation. Rather, the use of micellar casein, which releases calcium ions in a controlled manner, enables a homogeneously precipitated fibre structure. The amount of methyl cellulose added affects the strength of the fibre which can be adjusted depending on the intended use. While the process allows for a better control of fibre formation, the protein and dry matter content of the fibres produced is comparatively low and protein contents of more than 10% and dry matter contents of more than 22% are difficult to obtain. Because of the use of micellar casein as a precipitant, the product can only be classified as vegetarian.

All known, earlier described methods for producing protein-containing particles or fibres have in common that the fibre formation, in particular its hardening, can only be controlled with difficulty and in many cases results in a non-uniform hardening, which is badly suited for processes in the food industry. The exact curing time in these processes is difficult to estimate, at least if the process is carried out on an industrial scale. The process requires long contact times of the particles with the solution. This is because the diffusion time of calcium depends strongly on the diffusion distance. In other words, the larger particles require significantly longer curing times than smaller particles. Accordingly, a target setting of the particle diameter that is as small as possible is essential in order to obtain a curing time that is as short and predictable as possible. On the other hand, a minimal lower limit of the particle diameter is necessary for the sensory feeling. Accordingly, there is a minimal process time that cannot be undercut. This may be a matter of several hours, and due to the high degree of uncertainty, a significant time buffer must be planned. During this time, the particles must be stored in the aqueous solution of the bivalent metal salt, thereby increasing the storage volume of the particles by the volume of the calcium chloride solution. On an industrial scale, long-term, moist storage is problematic since large tanks or screw conveyors would be necessary and microbial spoilage is favored during this time. Moreover, at least the processes suggested for products based on plant proteins only achieve low dry matter and protein contents.

It is therefore an object of the present invention to provide a process which overcomes the drawbacks of prior art. In particular, the process should allow for producing protein products based solely on non-animal, i.e. vegetable and/or microbial proteins, and thus protein products, which qualify as vegan products. The process should allow for producing protein products based on vegetable and/or microbial proteins with uniform product quality, in particular with uniform particle hardness, regardless of their size. Moreover, the process should be capable of providing edible protein products having a high protein content and still have the aforementioned benefits of uniform product quality. In particular, the process should provide these benefits, if it is carried out on an industrial scale, e.g. on a scale of 10 tons per day or more.

It has been found that these objectives are met by the process which comprises the following steps i. to iv.:
i. providing a malleable mass containing
   a) 7 to 20% by weight, based on the total weight of the malleable mass, of an edible protein component a), which is selected from the group consisting of edible vegetable protein materials, edible microbial protein materials and mixtures thereof,
   b) 1 to 15% by weight, based on the total weight of the malleable mass, of an edible fat or oil of plant origin, hereinafter referred to as component b),
   c) 1 to 3.3% by weight, based on the total weight of the malleable mass, of a water-soluble organic polymeric gelling agent which is capable of being gelled by calcium ions, which is a water-soluble polysaccharide bearing carboxyl groups or a water soluble salt thereof, such as alginate or a pectin, in particular an alginate salt, especially sodium alginate, which is hereinafter referred to as component c),
   d) 0.05 to 0.6% by weight, based on the total weight of the malleable mass and calculated as elemental calcium, of a calcium salt being present in retarded form which releases its calcium ions to the mass in a delayed manner upon heating the malleable mass and/or by lowering the pH value of the malleable mass, hereinafter referred to as component d) and
   e) 55 to 90% by weight, based on the total weight of the malleable mass, of water, hereinafter referred to as component e);
ii. comminuting the malleable mass into particles and bringing the particles into contact with an aqueous solution of a calcium salt to achieve a hardening of the particle surface, where during step ii. conditions are applied which effect the release of the calcium ions from the retarded form of the calcium salt, where the release of calcium ions is effected by a controlled increase of the temperature of the malleable mass and/or by a controlled lowering of the pH value of the malleable mass;
iii. separating the aqueous solution from the particles, and
iv. subsequently allowing the particles to harden to achieve their final hardness.

Therefore, the present invention relates to a process for preparing a vegan edible product from an edible non-animal protein material comprising the steps i. to iv. as described herein.

The process of the present invention has considerable advantages over the prior art. As the hardening of the interior of the particles does no longer depend on the diffusion of the calcium ions from the solution into the particles, the hardening and hardening time are no longer depending on the particle size and the shape of the particles. Furthermore, it is not necessary to drag along a large volume of a curing solution during the hardening time as explained below. Yet, the time for achieving final hardness of the particles is significantly shorter than in the prior art methods which solely rely on the diffusion of bivalent ions into the particles.

By including a calcium salt in retarded form into the malleable mass and triggering the release of the calcium ions at least during step ii. a very uniform hardening of the particles is achieved, as not long-time diffusion is required and the hardening of the particles is no longer dependent on the particle size. Rather, hardening essentially occurs uniformly within the particles and only depends on the speed of the release, which is faster on average than the diffusion of calcium ions into the particles. Therefore, it is much easier to estimate the process time because large buffer time no longer needs to be planned. When bringing the particles formed by the comminution of the malleable mass into contact with the aqueous solution of the calcium salt a firm skin is very quickly created on the surface of the particles. Therefore, the resulting particles can be removed from the bath very quickly, e.g. after few minutes, and easily transported like a solid. Thus, the storage volume only corresponds to the particles without the volume of a curing solution. Moreover, curing takes place in the dry and even under cold storage, with faster total curing time for the above reasons. The process time is thereby shortened, time buffers are no longer necessary, the effects of particle size and particle shape on the hardening is significantly reduced, the transport is simplified, and the storage volume is reduced. Production on a higher volume scale is therefore significantly simplified.

The process yields a particulate protein material, hereinafter also termed as protein fibre, which can be easily processed to an artificial meat product. Therefore, the present invention also relates to a process for preparing a vegan artificial meat product which comprises producing a vegan edible product from edible vegetable and/or microbial proteins by the process as defined herein, followed by processing the vegan edible product to vegan artificial meat products. The processing can be carried out by analogy to the known methods of processing protein material to artificial meat products. The vegan edible products obtained by the process of the present invention can be used for producing vegan artificial meat products of any quality including vegan artificial meat products with a texture or mouthfeel comparable to meat or meat products from mammalian meat such as pork, beef, veal, lamb or goat, from poultry such as chicken, duck or goose, and products comparable to fish or seafood.

The invention is hereinafter explained in detail. Further embodiments can also be taken from the claims.

As the process relates to the production of edible products, a skilled person will immediately understand that all of the compounds and components, respectively, used for the production are edible constituents or at least are authorized additives for use in food, e.g. according to Regulation (EC) No 1333/2008 of the European Parliament and of the Council of 16 Dec. 2008 on food additives. As the process is directed to the preparation of a vegan edible product, a skilled person will immediately understand that all compounds and components, respectively, used in this process are in particular not of animal origin. In particular, no components of animal origin, such as animal protein components and animal fat, are used in this process. In particular, the process is carried out in the absence of any animal protein.

The term “edible protein material”, i.e. the component a), refers to a material highly enriched with edible protein, i.e. which typically has an analytical protein content of at least 70% by weight, in particular from 80 to 95% by weight in dry matter. The protein material of component a) is typically obtained by isolation from a natural, non-animal protein source, e.g. from a protein containing plant or a microorganism. Besides the protein, the protein material may contain other edible ingredients, such as carbohydrates and fats/oils contained in the protein source. Preferably, the edible protein material of component a) is a protein isolate. Such a protein isolate generally has a protein content in the range of 80 to 95% in dry matter. The protein material of component a) may also be a protein concentrate, which however, preferably has an analytical protein content of at least 70% by weight in dry matter.

Any amounts of component a) in the malleable mass given here refer to the amount of the component a) as such.

The term “non-animal protein material” refers to vegetable protein materials, microbial protein materials and mixtures thereof.

Here and in the following, the term “edible vegetable protein material” is a protein material from a vegetable source, i.e. from plants, which is suitable as food or food component for human nutrition.

Here and in the following, the term “edible microbial protein material” is a protein material from a microorganism source, i.e. from fungi, yeast or bacteria, which is suitable as food or food component for human nutrition. In this context, protein from algae protein material may be considered both as a microbial protein material or as a vegetable protein material.

Here and in the following, the terms “internal hardening” and “internal setting” refer to the hardening resulting from the retarded calcium salt contained in the malleable mass.

Here and in the following the terms “diffusion process”, “diffusion hardening” and “diffusion setting” refer to the hardening of the particles formed from the malleable mass by the contact with the aqueous solution of the calcium salt.

With respect to calcium salts and acids the terms “coated” and “encapsulated” are used synonymously.

Here and in the following, the term “artificial meat product” includes any edible protein product produced from a non-animal protein material and having a texture or mouthfeel which is comparable to natural meat or products made from natural meat, including mammalian meat, such as pork, beef, veal, lamb or goat, meat from poultry, such as chicken, duck or goose, meat from fish or seafood.

According to the invention, the malleable mass contains a retarded form of the calcium salt, i.e. a calcium salt, which is capable of releasing its calcium ions to the water contained in the malleable mass in a delayed manner. In this context, the term “delayed” means that the calcium salts are not immediately completely released when the salt is getting into contact with water but only after the release is effected. Hereinafter, the retarded form of the calcium salt is also referred to as component d). According to the invention, the release of the calcium ions from the retarded form is effected by controlled heating of the malleable mass or by controlled lowering the pH of the malleable mass or by both measures.

A skilled person will readily understand that controlled lowering the pH of the malleable mass means decreasing the pH value of the malleable mass, which typically has a pH value of >5, in particular pH >5.5 or pH >6.0, e.g. in the range of pH >5 to pH 7, for a sufficient time period to a pH value at which the calcium salt of component d) contained in the malleable mass dissolves and releases calcium ions into the malleable mass. A skilled person will readily understand that lowering the pH value for a sufficient time period is achieved by including a sufficient amount of an acid or a retarded form on an acid into the malleable mass.

A skilled person will readily understand that controlled heating means an increase of the temperature of the malleable mass to a temperature at which the calcium salt of component d) contained in the malleable mass dissolves and releases calcium ions into the malleable mass.

For example, the retarded form may be a calcium salt, which has a poor solubility in deionized water, i.e. a solubility in deionized water at 20° C. of less than 2.5 g/L, in particular less than 1.0 g/L but whose solubility can be increased by lowering the pH value of the malleable mass, e.g. by lowering the pH value to a range of pH 1 to pH 6, in particular to a pH in the range of pH 2 to pH 5. The retarded form of the calcium salt may also be a form that dissolves in water only slowly or even not for kinetic reasons but whose dissolution rate can be increased by heating, e. g. by increasing the temperature of the malleable mass during or after comminution, e.g. to a range of 40 to 95° C., in particular 50 to 90° C. The measures of lowering the pH and increasing the temperature can of course be combined.

According to a first group of embodiments, the retarded form of the calcium salt is selected from calcium salts that have a solubility in deionized water at 20° C. of less than 2.5 g/L, in particular less than 1.0 g/L, but whose solubility can be increased by lowering the pH value of the malleable mass. These calcium salts are hereinafter also referred to as sparingly water-soluble calcium salts. Sparingly water-soluble calcium salts having a solubility in deionized water at 20° C. of less than 1.0 g/L are also referred to as water-insoluble salts. Such sparingly water-soluble or even water-insoluble calcium salts, include, but are not limited to calcium sulfate, calcium carbonate, dicalcium phosphate, tricalcium phosphate and dicalcium pyrophosphate, including the hydrates of the aforementioned salts. Particular preference is given to calcium carbonate.

If the retarded form of the calcium salt is selected from sparingly water-soluble calcium salts, the malleable mass also contains an acid component, i.e. acid and/or an or acid precursor, which is capable of lowering the pH value of the malleable mass during step ii., thereby furthering the dissolution of the sparingly water-soluble calcium salt contained in the malleable mass. Hereinafter, the acid or acid precursor is also referred to as component d′). Typical acids and acid precursors are those which are suitable for foodstuff. In particular, the acid is selected from acids, whose 1% by weight solution in deionized water at 20° C. results in a pH value in the range of pH 1.5 to pH 5.0. Examples of suitable acids include, but are not limited to acetic acid, lactic acid, ascorbic acid gluconic acid, alkali metal dihydrogen orthophosphates, such as sodium dihydrogen orthophosphate and alkali metal dihydrogen pyrophosphate salts, such as disodium dihydrogen pyrophosphate. An acid precursor is a compound, which upon hydrolysis results in an acid, in particular an acid whose 1% by weight solution in deionized water at 20° C. results in a pH value in the range of pH 1.5 to pH 5.0. Suitable acid precursors are lactones, in particular lactones of aldonic acids, more specifically delta-lactones of aldonic acids, with particular preference given to glucono-delta-lactone.

In order to better control the release of the protons from the acid source and thus the dissolution of the sparingly water-soluble calcium salts and consequently the release of the calcium ions, the acid component is preferably provided as a coated acid or as an acid precursor, which may be coated or not coated. In case of an acid precursor, a coating is usually not required, since hydrolysis typically is not very rapid and thus provides for the delayed release of protons. However, the acid precursor may be provided to the malleable mass as a coated acid precursor. The terms “coated acid” and “coated acid precursor” refer to solid acid particles and solid acid precursor particles, respectively, which are coated with a coating which delays the release of protons, e.g. by delaying the dissolution of the acid. Suitable coated acids and coated acid precursors include coated lactic acid, coated ascorbic acid, coated gluconic acid, coated glucono-delta-lactone, coated alkali metal dihydrogen orthophosphates, such as coated sodium dihydrogen orthophosphate and coated alkali metal dihydrogen pyrophosphate salts, such as coated disodium dihydrogen pyrophosphate.

The coating of the acid or acid precursor is typically a coating which either slowly dissolves in water or a coating which is solid at 20° C. but becomes liquid upon heating, in particular upon heating to a temperature of at least 50° C., in particular in the range of 50 to 90° C. Suitable coating materials, which become liquid upon heating, include but are not limited to wax, fat and hardened oil. In particular, the coating is a vegetable fat or oil, such as hardened sunflower oil or palm oil or another fat or hardened oil mentioned in the context of component b). The amount of coating is typically in the range of 20 to 80% by weight, in particular 30 to 60% by weight, based on the total weight of the coated acid or acid precursor. The coated acid or coated acid precursor is typically included into the malleable mass as a particulate material, e.g. as a powder of particles of the coated acid. Generally, at least 90% by weight of the particles of the coated acid have a particle size in the range of 50 to 1000 μm, in particular in the range of 100 to 500 μm. Generally, the mean particle size, i.e. the Dv50 value is in the range of 125 to 250 μm. The particle size can be determined by laser diffraction according to ISO 13320:2020-01. Coated acids and coated acid precursors, such as coated glucono-delta-lactone and coated ascorbic acid, are commercially available, e.g. from Extrakta Strauss, or they can be prepared by analogy to known processes for coating organic or inorganic particles.

At elevated temperatures the coating of the coated acid or the coated acid precursor is rapidly destroyed, e.g. melted or dissolved, and the acid rapidly dissolves and the pH of the particles formed from the malleable mass is decreased from a pH of approx. 6 to a value of at least pH 5 in the presence of calcium salt, whilst the acids alone—without calcium salt—are able to decrease the pH even down to 2. In this case, the dissolution of the sparingly soluble calcium salt, i.e. the release of calcium ions into water contained in the particles, is effected by heating the particles formed from the malleable mass. For this, generally, temperatures of at least 40° C., in particular at least 50° C. and especially at least 60° C. will be sufficient, depending on the type of the coating. Preferably, the particles are heated to temperatures in the range 40 to 95° C., in particular in the range of 50 to 90° C., especially 60 to 75° C. to effect the dissolution of the coated acid and thus the dissolution of the sparingly water-soluble calcium salt.

The quantity of the acid component, i.e. the acid or the acid precursor, is generally chosen so that it provides at least enough protons to dissolve at least 90 mol-%, in particular at least 95 mol-% or the total amount of the sparingly soluble calcium salt used. In other words, the quantity of the acid component is generally chosen so that it theoretically provides at least 2 mol or, in particular at least 2.1 mol protons per 1 mol of calcium ions contained in the sparingly water-soluble calcium salt. Generally, the amount of acid source is chosen so that the amount of protons theoretically provided by the acid source does not exceed 3 mol per mol of calcium ions contained in the sparingly water-soluble calcium salt.

According to a second group of embodiments, the retarded form of the calcium salt is selected from water-soluble calcium salts whose dissolution in water is kinetically hampered, for example by a coating. By controlled heating of the malleable mass, the dissolution of the calcium salt is effected by overcoming the kinetic hindrance of the dissolution and thus the calcium ions are released. In this second group of embodiments, the calcium salt itself has a good solubility in deionized water at 20° C. of higher than 2.5 g/L, e.g. at least 5 g/L or at least 10 g/L. In this second group of embodiments, the coated calcium salt is coated calcium chloride, coated calcium lactate and coated calcium gluconate and where the coated calcium salt is in particular coated calcium lactate.

The coating of the water-soluble calcium salt is typically a coating which either slowly dissolves in water or a coating which is solid at 20° C. but melts, i.e. it becomes liquid, upon heating, in particular upon heating to a temperature in the range of 50 to 90° C. Suitable coating materials, which become liquid upon heating, include but are not limited to wax, fat and hardened oil. In particular, the coating is a vegetable fat or oil, such as hardened sunflower oil or palm oil or another fat or hardened oil mentioned in the context of component b). The amount of coating is typically in the range of 20 to 80% by weight, in particular 30 to 60% by weight, based on the total weight of the coated calcium salt. At elevated temperature the coating is rapidly melted and the calcium salt dissolves. Thus, the release of calcium ions is effected by heating the particles formed from the malleable mass. For this, generally, temperatures of at least 40° C., in particular at least 50° C. and especially at least 60° C. will be sufficient. Preferably, the particles are heated to temperatures in the range 40 to 95° C., in particular in the range of 50 to 90° C., especially 60 to 75° C., to effect the release of the calcium ions from the coated water-soluble calcium salt. Coated calcium salts are commercially available, e.g. coated calcium lactate (Balchem) or they can be prepared by analogy to known processes for coating inorganic salts, e.g. coated calcium chloride.

Irrespective of whether the retarded form of the calcium salt belongs to the first or to the second group of embodiments the retarded form is typically included into the malleable mass as a particulate material, e.g. as a powder or as a suspension of particles of the retarded form. Generally, at least 90% by weight of the particles of the retarded form of the calcium salt have a particle size in the range of 50 to 1000 μm, in particular in the range of 100 to 500 μm. Generally, the mean particle size, i.e. the Dv50 value is in the range of 125 to 250 μm. The particle size can be determined by laser diffraction according to ISO 13320:2020-01.

Irrespective of whether the retarded form of the calcium salt belongs to the first or to the second group of embodiments the amount of the retarded form of the calcium salt in the malleable mass is such that the weight ratio of calcium ions to the polymeric gelling agent of component c) contained in the malleable mass is generally in the range of 1:45 to 1:2, in particular in the range of 1:27 to 1:2.5 and especially in the range of 1:7 to 1:5, calculated as sodium salt of the polymeric gelling agent. For example, if the polymeric gelling agent is alginate, such as sodium alginate, the amount of the retarded form of the calcium salt in the malleable mass is such that the weight ratio of calcium ions to alginate, calculated as sodium alginate, contained in the malleable mass is generally in the range of 1:45 to 1:2, in particular in the range of 1:27 to 1:2.5 and especially in the range of 1:7 to 1:5. The amount of the retarded form of the calcium in the malleable mass may vary depending on the counter ion and on whether the retarded form is a coated calcium salt. Generally, the amount of the retarded form of the calcium salt is such that the amount of calcium contained in the retarded form of the calcium salt is in the range of 0.05 to 0.6% by weight, in particular in the range of 0.1 to 0.45% by weight, especially in the range of 0.2 to 0.4% by weight, based on the total weight of the malleable mass and calculated as elemental calcium.

It has been found beneficial, if the malleable mass additionally contains a non-acidic alkali metal polyphosphate, in particular an alkali metal pyrophosphate or an alkali metal triphosphate, such as tetrasodium pyrophosphate, tetrapotassium pyrophosphate, sodium tripolyphosphate or potassium tripolyphosphate, in particular, if the malleable mass includes a sparingly water-soluble calcium salt and an acid or acid precursor, the latter being uncoated or coated. The non-acid polyphosphate, hereinafter referred to as component f) results in a delay in the initial phase of the hardening and thus allows to tailor the hardening process. In particular, it reduces or even avoids premature hardening of the malleable mass during its comminution and thus increases the handling time of the malleable mass. Apart from that, the component avoids too rapid hardening at the beginning and thus achieves an improved homogeneity of the protein product. The amount of non-acidic alkali metal polyphosphate required for achieving a sufficient delay can be estimated from the amount of calcium ions initially released. The amount of the non-acidic alkali metal polyphosphate, if present, is generally in the range of 0.01 to 0.5% by weight, in particular in the range of 0.02 to 0.5% by weight and especially in the range of 0.1 to 0.5% by weight, based on the total weight of the malleable mass.

As a component a), the malleable mass contains a vegetable protein material and/or a microbial protein material or a mixture thereof, which is suitable for nutrition purposes, in particular for human nutrition. Hereinafter, the edible vegetable and/or microbial protein material is also referred to as component a) or protein component. In particular, the protein component does not contain any protein of animal origin. Apart from that, the kind of protein is of minor importance and may be any vegetable protein or microbial protein, which is suitable for nutrition purposes. Preferably, the edible protein material of component a) is an isolate. Such a protein isolate generally has an analytical protein content in the range of 80 to 95% in dry matter.

Examples of vegetable protein materials are protein materials from pulses, such as chickpea, faba bean, lentils, lupine, mung bean, pea or soy, protein materials from oil seed, such as hemp, rapeseed/canola or sunflower, protein materials from cereals, such as rice, wheat or triticale, further potato protein, and protein materials from plant leaves such as alfalfa leaves, spinach leaves, sugar beet leaves or water lentil leaves, and algae protein and mixtures thereof.

Examples of microbial proteins, which are also termed single cell proteins (SCP) include fungal proteins, also termed mycoproteins, such as proteins from Fusarium venenatum, proteins from yeast such as proteins from Saccharomyces species, proteins from algae, such as proteins from spirulina or chlorella species, and bacterial proteins, such as proteins from lactobacilli species.

Preference is given to a protein component a), which comprises at least 90% by weight, based on the total amount of protein component a) in the malleable mass, or consists of one or more vegetable protein materials. In particular, the protein component a) comprises or consists to at least 90% by weight, based on the total amount of protein component a) in the malleable mass, of at least one vegetable protein material selected from isolates and concentrates of chickpea protein, faba bean protein, lentil protein, lupine protein, mung bean protein, pea protein or soy protein and mixtures thereof, with preference given to the isolates of the aforementioned protein material. In a particular group of embodiments, the component a) comprises or consists to at least 90% by weight, based on the total amount of protein component a) in the malleable mass, of at least one vegetable protein material selected from pea protein material and faba bean protein material or a mixture thereof, especially, if a fully allergen free product is required.

Vegetable protein materials as well as SCP having food grade are well known and commercially available.

Apart from water, the protein component a) is typically the main constituent of the malleable mass. It is generally constitutes at least 20% by weight and may constitute up to 75% by weight, based on the total amount of components different from water, hereinafter referred to as dry matter, in the malleable mass and calculated as the amount of protein component. The amount of the component a) in the malleable mass is generally in the range of 7 to 20% by weight, in particular in the range of 10 to 18% by weight and especially in the range of 13 to 16% by weight based on the total weight of the malleable mass. As the protein component usually has a protein content of at least 70% by weight, in particular of about 80 to 95% by weight (analytical protein content in dry matter), the analytical protein content is typically somewhat lower and constitutes frequently at least 16% by weight and up to 72% by weight, of the dry matter in the malleable mass. The amount of the protein component a) is generally chosen such that the analytical protein content in the malleable mass is generally in the range of 5 to 18% by weight, in particular in the range of 7 to 16% by weight and especially in the range of 9 to 14% by weight, which usually corresponds to an amount of protein isolate in the range of 7 to 20% by weight, in particular in the range of 10 to 18% by weight and especially in the range of 13 to 16% by weight, based on the total weight of the malleable mass.

The malleable mass further contains an edible fat or oil, which are hereinafter also referred to as component b). Typically, the component b) is a vegetable fat or oil, i.e. of plant origin. Apart from that, the type of fat or oil is of minor importance. Suitable vegetable fats or oils include, but are not limited to oils commonly used for cooking such as sunflower oil, corn oil, rapeseed oil, including also canola oil, coconut oil, cottonseed oil, olive oil, peanut oil, palm oil, palm kernel oil, safflower oil, soybean oil, sesame oil, and mixtures thereof. The edible fats or oils may also include nut oils, oils from stone fruits such as almond oils and apricot oil, oils form melon or pumpkin, flaxseed oil, grapeseed oil, and the like and mixtures thereof with the aforementioned fat or oils for cooking. In particular, the amount of fats or oils used commonly used for cooking amount to at least 50% by weight, based on the total amount of fat or oil in the malleable mass. The amount of oil in the malleable mass may vary and may be as low as 1% by weight or as high as 15% by weight. In particular, the total amount of edible fat or oil in the malleable mass is in the range of 5 to 10% by weight, based on the total weight of the malleable mass.

According to the invention, the malleable mass also contains an organic polymeric gelling agent as component c). The organic polymeric gelling agent is a water-soluble polysaccharide bearing carboxyl groups or are water soluble salts thereof, which are capable of being gelled by calcium ions. If the polysaccharide bearing carboxyl groups is not sufficiently water soluble, it is typically used as a water-soluble salt thereof. Water soluble salts include the alkali metal salts, in particular the sodium salts, and the ammonium salts, with preference given to the sodium salts.

Preferably, the component c) is a polysaccharide wherein the majority of saccharide units, in particular at least 65 mol-% of the saccharide units, which form the polysaccharide, are uronic acid units, such as units of guluronic acid, mannuronic acid and galacturonic acid. The uronic acid units are preferably 1,4-connected. Examples of carboxyl groups bearing polysaccharides which are capable of being gelled with calcium ions are alginates and pectins. Alginates are well known gelling additives in food. They are authorized food additives, namely E400 to E405. Amongst alginates, preference is given to sodium alginate. Likewise pectins are well known gelling additives in food (E440). Amongst pectins, preference is given to low-methoxy pectins and their salts.

According to the invention, the concentration of the component c) in the malleable mass is in the range of 1 to 3.3% by weight, in particular in the range of 1.1 to 2.8% by weight, especially in the range of 1.2 to 2.3% by weight, based on the total weight of the malleable mass. Preferably, the weight ratio of the total amount of the component a) to the component c) to in the malleable mass is in the range of 2:1 to 20:1.

Preferably, the component c) is selected from the water-soluble salts of alginic acid, in particular the sodium salts, low-methoxy pectins, and their water soluble salts and mixtures thereof.

In a very preferred group of embodiments, the component c) is a water soluble salt of alginic acid, hereinafter referred to as alginate. The preferred alginate is sodium alginate. The amount of alginate in the malleable mass is in particular in the range of 1.1 to 2.8% by weight, especially in the range of 1.2 to 2.3% by weight, based on the total weight of the malleable mass and calculated as sodium alginate, also referred to as E 401.

In another group of embodiments, the alginate is partly or totally replaced by one or more other polysaccharide bearing carboxyl groups, which are capable of being gelled by calcium ions. Such polysaccharides that are different from alginate include but are not limited to pectins, in particular low-methoxy pectins and their water soluble salts. These polysaccharide bearing carboxyl groups may be used in their acidic form or in the form of their alkali metal salts, and in particular in the form of their sodium salts. Preferably, the amount of such polysaccharide bearing carboxyl groups will not exceed the amount of alginate. In particular, the amount of alginate will typically make up at least 80% by weight of the total amount of alginate and other polysaccharide bearing carboxyl groups.

Especially, the alginate is the sole gelling agent contained in the malleable mass.

Apart from that, the malleable mass contains water as component e). The amount of water is generally in the range of 55 to 90% by weight in particular 60 to 84% by weight or 64 to 78% by weight or 68 to 72% by weight, based on the total weight of the malleable mass, of water.

The malleable mass may further contain a non-ionic polysaccharide, which is capable of being dissolved or swollen in cold water. This non-ionic polysaccharide is hereinafter referred to as component g). As a non-ionic polysaccharide, particular preference is given to methyl cellulose, also referred to as E 461. The non-ionic polysaccharide, in particular methyl cellulose, serves for modifying the hardness of the particles and particularly increases the thermal stability of the fibre. A generally observed loss of hardness of the particles when heated for hot consumption is reduced and thus the texture is better preserved. Instead of methyl cellulose or in combination therewith starch flour or plant fibres can be used. If present, the amount of non-ionic polysaccharide, in particular of methyl cellulose, is typically in the range of 0.01 to 1% by weight, based on the total weight of the malleable mass.

In particular, the malleable mass contains
a) 7 to 20% by weight, in particular 10 to 18% by weight and especially 13 to 16% by weight based on the total weight of the malleable mass, of the protein component a) which typically corresponds to an analytical protein content in the malleable mass in the range of 5 to 18% by weight, in particular in the range of 7 to 16% by weight and especially in the range of 9 to 14% by weight;
b) 1 to 15% by weight, in particular 5 to 10% by weight, based on the total weight of the malleable mass, of the component b), i.e. an edible fat or oil of plant origin;
c) 1 to 3.3% by weight, in particular in the range of 1.1 to 2.8% by weight, especially in the range of 1.2 to 2.3%, based on the total weight of the malleable mass, of component c), where the component c) is in particular alginate or a mixture thereof with a pectin, and where the component c) is especially sodium alginate, preferably such that the weight ratio of sodium alginate to the edible protein material, e. g. the protein isolate, in the malleable mass is in the range of 1:2 to 1:20;
d) 0.05 to 0.6% by weight, in particular 0.1 to 0.45% by weight, especially 0.2 to 0.4% by weight, based on the total weight of the malleable mass and calculated as elemental calcium, of the retarded form of the calcium salt, and where the weight ratio of calcium ions in the retarded form to component c), calculated as its sodium, contained in the malleable mass is generally in the range of 1:45 to 1:2, in particular in the range of 1:27 to 1:2.5 and especially in the range of 1:7 to 1:5; and
e) 55 to 90% by weight in particular 60 to 84% by weight or 64 to 78% by weight or 68 to 72% by weight, based on the total weight of the malleable mass, of water; and optionally one or both of the following components f) and g):
f) optionally 0.01 to 0.5% by weight, in particular in the range of 0.02 to 0.5% by weight and especially in the range of 0.1 to 0.5% by weight, of a non-acidic alkali metal polyphosphate, herein also referred to as component f);
g) optionally 0.01 to 1% by weight of a nonionic polysaccharide, in particular methyl cellulose, herein also referred to as component g).

Furthermore, the malleable mass may contain small amounts of additives conventionally used in edible protein materials, which include, but are not limited to, sweeteners, spices, preservatives, color additives, colorants, antioxidants, etc. The total amount of such ingredients will generally not exceed 1% by weight of the malleable mass and may be in the range of 0.01 to 1% by weight, based on the total weight of the malleable mass.

A skilled person will immediately understand that the total amount of the ingredients of the malleable mass will add to 100% by weight and any combination of the aforementioned amounts that deviates from 100% by weight will be compensated by reducing or increasing the amount of water.

The malleable mass is generally prepared by mixing the ingredients of the malleable mass in their respective amounts, preferably with mixing and shearing. Usually, the components a), c), d), optionally d′) and optionally f) are powders, which are added to the water in an arbitrary order or as a pre-blend in a suitable mixing device, followed by the addition of oil.

If the malleable mass contains methyl cellulose, it may be added together with the components a), c), d), optionally d′) and optionally f). Although methyl cellulose is a powder and thus can be added as such, it is beneficial, if methyl cellulose is used as a solution in water, e.g. as a 0.1 to 5% by weight aqueous solution. In particular methyl cellulose is used in its pre-hydrated form. For this, methyl cellulose is mixed with cold water, which preferably has a temperature in the range of 0 to 20° C., in particular 0 to 5° C., with shearing to obtain a virtually homogeneous gel of hydrated methyl cellulose. For obtaining the pre-hydrated methyl cellulose typically about 0.5 to 5 g of methyl cellulose per 100 g of water are used.

Preferably, the components of the malleable mass are mixed with shearing. Mixing and shearing can be carried out successively or simultaneously. Shearing results in a homogenization of the component in water such that they are evenly distributed. Suitable apparatus for mixing and shearing include bowl choppers, cutters, such as Stephan cutters, high speed emulsifiers, in particular those based on the rotor-stator principle, colloid mills and combinations thereof with a blender. The thus obtained malleable mass has typically a dough like consistency.

The malleable mass is generally prepared at temperatures in the range of 10° C. to 95° C., in particular in the range of 15 to 75° C. In other words, mixing and shearing is carried out at these temperature ranges. If one of the components d) or d′) is a coated material, the preparation of the malleable mass is typically carried out at temperatures of less than 40° C. in order to avoid a dissolution or melting of the coating during the preparation of the malleable mass. In this case, the preparation, i.e. the shearing and mixing is generally carried out at temperatures in the range of 10° C. to <40° C., in particular at temperatures in the range of 15° C. to 25° C. If none of the components d) and d′) is a coated material, e.g. in case a water insoluble calcium salt, such as calcium carbonate, and an uncoated acid precursor, such as glucono-delta-lactone, is used, then the preparation can be carried out at temperatures in the range of 10° C. to 95° C., in particular in the range of 72° C. to 90° C.

In step ii. of the process of the invention, the malleable mass is comminuted and brought into contact with the aqueous solution of a calcium salt. By the comminution, the malleable mass is formed into particles, which are mechanically instable. By bringing the particles in contact with the aqueous solution of the calcium salts, the calcium ions will immediately crosslink the alginate molecules on the surface of the particles and thus also gellify/harden the particles on its surface. Thereby, a rigid skin on the surface of the particles is formed, which stabilize the particles. This is also termed initial diffusion setting.

Generally, the comminution of the malleable mass is carried such that the majority of the formed particles, i.e. at least 90% by weight of the particles, are not to small but also not too big and have a size of at least 5 mm, e.g. in the range of 5 to 100 mm, and in particular, in its smallest spatial distance, in the range of 10 to 50 mm. However, the hardening of the particles is no longer dependent on the particle size and smallest diameter.

Comminution of the malleable mass and bringing thus formed particles into contact with the aqueous solution of the calcium salt can be carried out simultaneously or successively.

If comminution of the malleable mass and bringing the thus formed particles into contact with the aqueous solution of the calcium salt is carried out simultaneously, the malleable mass is comminuted in the presence of the aqueous solution of the calcium salt. In this case, comminution is typically carried out by stirring or kneading the mixture of the malleable mass and the aqueous solution of the calcium salt. For example, the aqueous solution of the calcium salt may be mixed with the malleable mass over a period of time, e.g. for 2 to 15 minutes, while comminuting the mass to particles, e.g. by stirring or kneading, e.g. in a paddle mixer. For this, the aqueous solution may be added to the malleable mass or the malleable mass is added to the aqueous solution of the calcium salt and the comminution in the thus obtained mixture. Comminution is carried out such that the majority of the formed particles, i.e. at least 90% by weight of the particles, are not too small and have a size in the ranges given above.

Preferably, comminution of the malleable mass and bringing the thus formed particles into contact with the aqueous solution of the calcium salt is carried out successively. For this, step ii. preferably comprises passing the malleable mass through a grid or a perforated plate into the aqueous solution of the calcium salt. It is also possible to pre-shape the mass by combined filling and cutting device, e.g. by a ball former with a diaphragm knife system. By passing the malleable mass through a grid, a perforated plate or a diaphragm, particles are formed, which have a size essentially defined by the size of the perforation of the plate or the mesh size of the grid or the diaphragm, respectively. The thus formed particles are then introduced into the aqueous solution of the calcium salt. Preferably, the aqueous solution is stirred while the particles of the malleable mass are introduced into the solution, in particular, if the initially formed particles need to be further comminuted. Thus, the particle size can also be adjusted by the intensity of the stirring.

Nevertheless, with the combination of the initial diffusion hardening followed by the internal setting the particle size is no longer as important for the hardening process, since the particles are mainly cured from the inside.

The temperature of the aqueous solution of the calcium salt is typically in the range of 5 to 95° C. For example, if the malleable mass is prepared at a temperature of 40° C. or higher, the temperature of the aqueous solution of the calcium salt is of minor importance and may be in the range of 5° C. to 90° C. However, the temperature of the aqueous solution of the calcium salt may then also have a lower temperature, e.g. a temperature in the range of 5° C. to 40° C., in particular at temperatures in the range of 5° C. to 20° C.

If the malleable mass is prepared at a temperature of below 40° C., e.g. in the range of 15° C. to <40° C., e.g. because one of the components d) and d′) is a coated material, the aqueous solution has preferably a temperature in the range of 40° C. to 95° C., in particular in the range of 50° C. to 90° C. or 60° C. to 75° C. By maintaining a temperature of in particular at least 50° C., especially at least 60° C., the coating of coated material is efficiently melted and an efficient release of the respective component is achieved.

Regardless of whether comminution of the malleable mass and bringing thus formed particles into contact with the aqueous solution of the calcium salt is carried out simultaneously or successively, the aqueous solution of the calcium salt has generally a concentration of calcium in the range of 0.5 to 1.5% by weight, based on the total weight of the aqueous solution of the calcium salt. The type of calcium salt for producing the aqueous solution of the calcium salt is of minor importance, as long as it is sufficiently soluble in water at the respective temperature and is acceptable for nutritional purposes. Suitable salts for producing the solution include, but are not limited to calcium chloride, calcium lactate, calcium gluconate and combinations thereof.

Regardless of whether comminution of the malleable mass and bringing thus formed particles into contact with the aqueous solution of the calcium salt is carried out simultaneously or successively, the mass ratio of the aqueous solution of the calcium salt to the particles formed from the malleable mass is in the range of 1:3 to 3:1, in particular in the range of 1:2 to 2:1 and especially of about 1:1.

While the comminuted malleable mass, i.e. the particles formed by the comminution, are in contact with the aqueous solution of the calcium salt, the temperature of the mixture is generally in the range of 5 to 90° C., in particular in the range of 5 to 20° C.; for particles containing coated components d) or d′), the temperature of the mixture is preferably in the range of 50 to 75° C.

As explained above, a rigid skin is formed on the surface of the particles formed by comminution, while the particles are in contact with the aqueous solution of the calcium salt. The formation of the rigid skin occurs quite rapidly and generally contact times of some seconds, e.g. at least 1 minute in particular at least 2 minutes are necessary to obtain a sufficient stability for handling the particles. For practical reasons contact times of more than 240 minutes, in particular more than 120 minutes especially more than 60 minutes or more than 30 minutes or more than 15 minutes are not required. Contact times in the range of 2 to 60 minutes, in particular in the range of 2 to 30 minutes, especially in the range of 2 to 15 minutes are preferred. In particular, the particles are contacted with an aqueous solution of the calcium salt for a contact period in the range of 1 to 240 minutes, in particular in the range of 2 to 60 minutes, and even more particular in the range of 2 to 15 min at a temperature in the range of 5 to 20° C., or for particles containing coated components d) or d′), the temperature of the mixture is generally in the range of 50 to 75° C.

After the contact time, the aqueous solution of the calcium salt is separated from the particles. Separation of the aqueous solution of calcium salt can be achieved by conventional methods of separating coarse solids from liquids, e.g. by sieving the mixture of particles and the aqueous solution of calcium salt or by decantation of the aqueous solution from the particles. For example, the mixture can be rinsed through a sieve or the particles can be removed from the solution with a sieve plate or by transporting the preformed particles, floating or swimming in the solution, with a belt conveyor, e.g. an inclined haulage conveyor, from the precipitation solution into trays or crates for dry curing. It is possible but not necessary to rinse the particles with water to remove adhering calcium salt.

After having removed the aqueous solution of the calcium salt, the particles are allowed to harden. Thereby, the particles achieve their final hardness, which is generally after 2.5 to 5 h (depending on the chosen retarded form of the calcium delivery) after the initiation of the internal setting which can be prior to or after the first contact with the aqueous solution of the calcium salt. The hardening is generally carried out at temperature in the range of 1 to 20° C., in particular in the range of 2 to 10° C. It may be preferred to allow the particles to harden at temperatures of at most 10° C. to reduce the risk of microbial spoilage.

The hardened particles can be optionally heat treated to a core temperature of ≥72° C. for better shelf-stability and stored cool at temperatures of <5° C., e.g. in a refrigerator, or deep frozen, e.g. at temperatures of below −18° C. in a deep freezer.

The particles obtainable by the process of the invention are particularly suitable for producing meat substitute products. For this, the particles are processed to meat substitute products by analogy to known methods as described in the prior art. For example, the meat substitute products can be produced by mixing the particles with binders of non-animal origin, such as hydrocolloids or plant fibres, and/or with herbs and spices, followed by shaping them to the desired shapes e.g. by using moulds or casings. The thus obtained shaped products can be portioned, optionally coated, e.g. with batters, breadcrumbs or external seasonings. Then the products are chilled, frozen or pasteurized and packaged for distribution as finished meat substitute products, such as burgers, nuggets, fish fingers, schnitzels, sausages and the like.

The invention is hereinafter explained by the following experiments and figures;
1) describing the components for a controlled calcium release, different kinds of retarded forms of calcium salts
   Water soluble calcium salts with coating like coated calcium lactate or coated calcium chloride, activated by heating,
   Sparingly water soluble calcium salts having a solubility in deionized water at 20° C. in the range of 1 to <2.5 g/L like calcium sulfate; optionally with a retarder,
   Water insoluble calcium salts like calcium carbonate activated by acid.
2) Solubility inducing mechanisms and substances by its effect on pH, such as glucono-delta-lactone or food acids or coated food acids, the latter activated by heating.
3) Retarder, such as coated glucono-delta-lactone, tetrasodium pyrophosphate or other polyphosphates, which are used to delay too early release or effect of calcium ions when internal gelling components are mixed with the malleable mass.

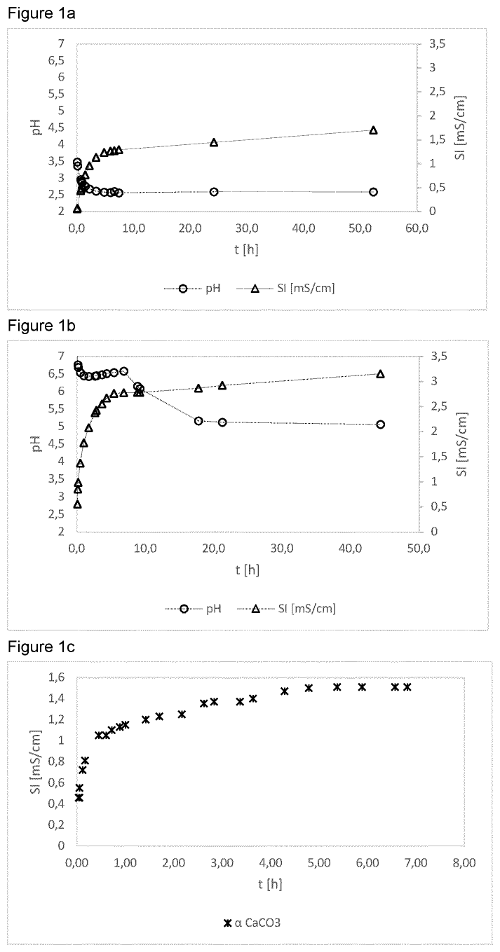

FIG. 1a-c: pH value and conductivity of aqueous solutions of glucono-delta-lactone and calcium carbonate with time; and calculated dissolution kinetics of calcium carbonate.

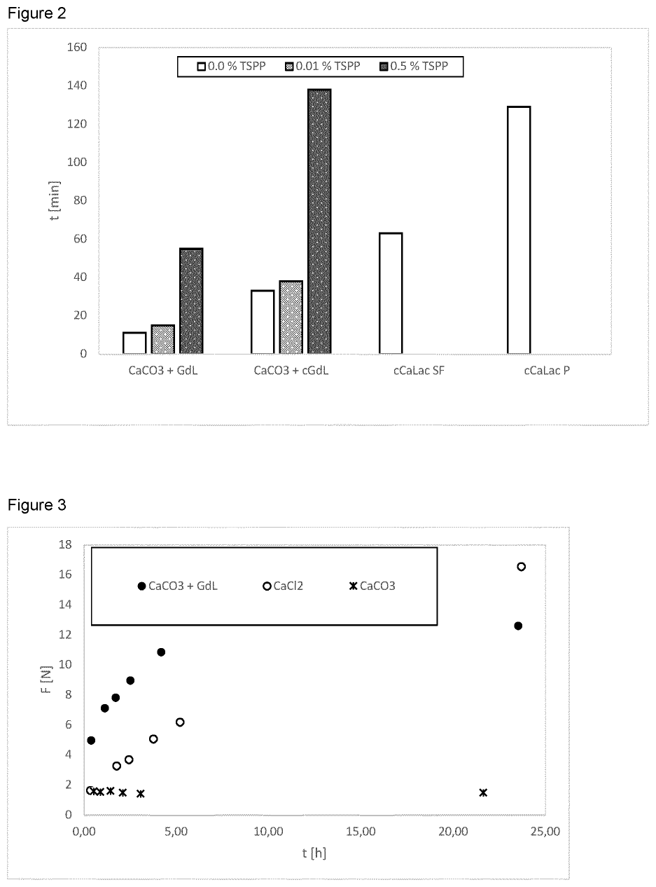

FIG. 2: Handling time of the malleable mass for different retarded forms of calcium salts, optionally an acid or acid precursor, optionally in the presence of tetrasodium pyrophosphate as a retarder.

FIG. 3: Development of the hardness, measured as compression force, for different setups (combined internal setting and diffusion setting vs. sole diffusion setting).

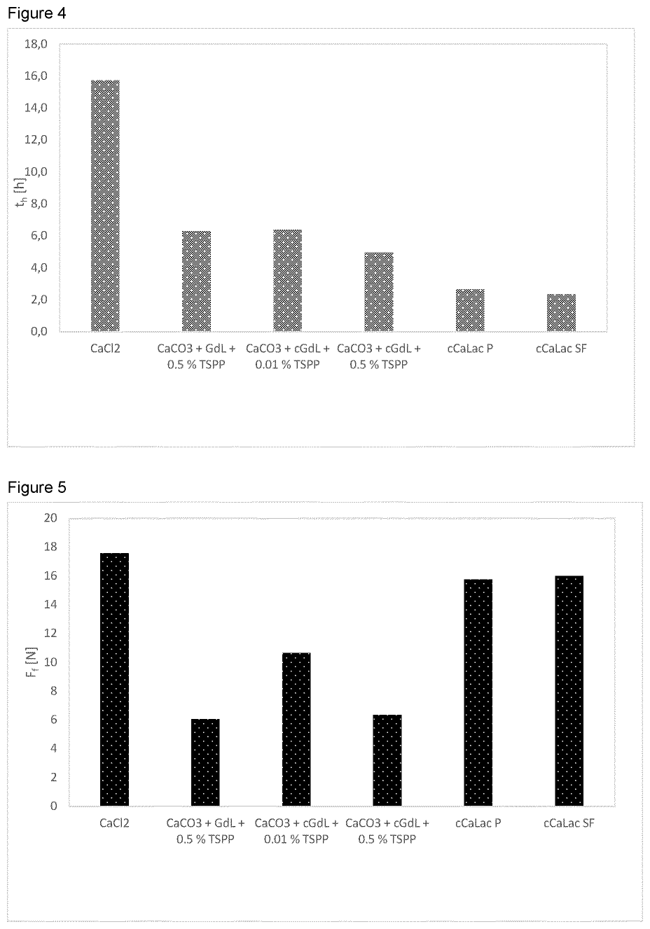

FIG. 4: Hardening time for different setups of combined setting with different pH-active, solubility-inducing acid sources, optionally in the presence of tetrasodium pyrophosphate, and retarded forms of the calcium salt vs. a reference example of only diffusion setting.

FIG. 5: Final Hardness for different setups of combined setting with different pH-active, solubility-inducing acid sources, optionally in the presence of tetrasodium pyrophosphate, and retarded forms of the calcium salt vs. a reference example of only diffusion setting.

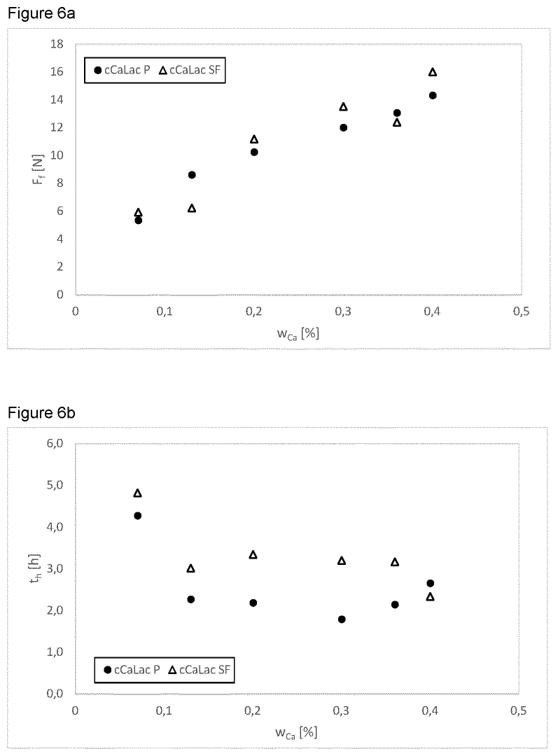

FIG. 6: Influence of calcium fraction on (a) final hardness and (b) hardening time of fibres hardened with coated (sunflower or palm coating) Ca-Lactate in different weight fractions (2.25 wt % alginate, 10.4 wt % pea protein isolate).

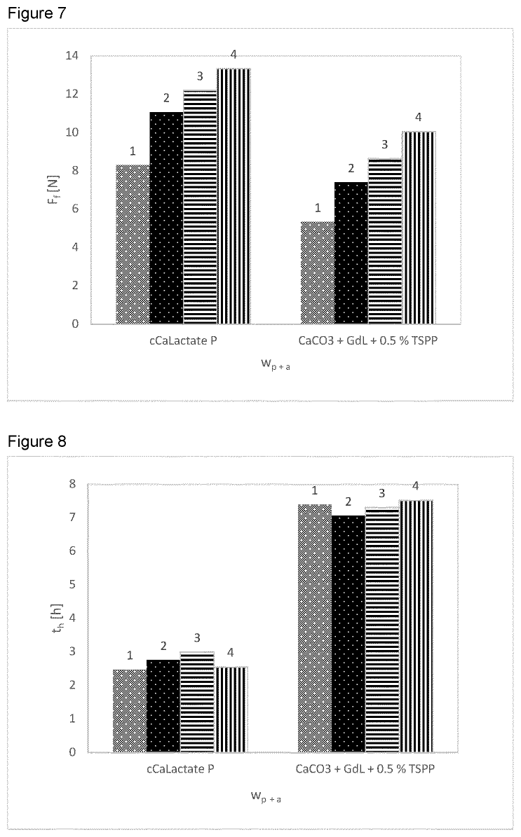

FIG. 7: Final Hardness for different protein and alginate levels.

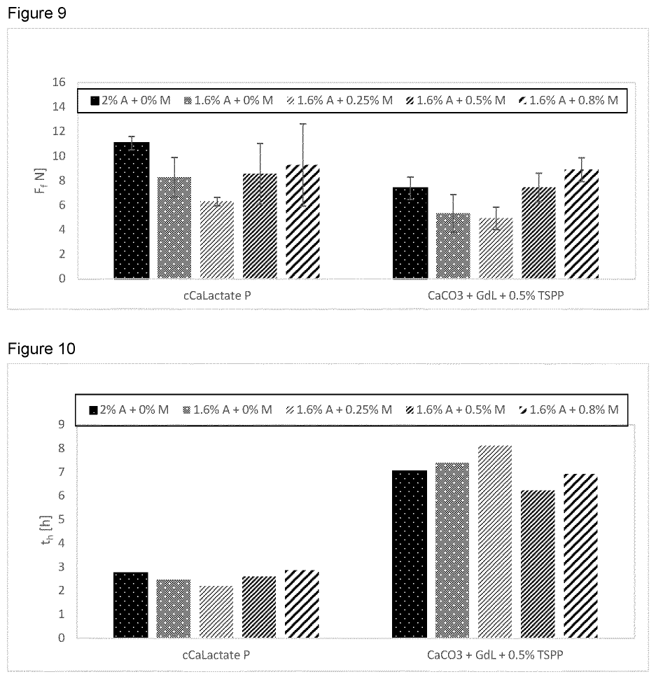

FIG. 8: Hardening time for different protein and alginate levels.

FIG. 9: Effect of methyl cellulose on the final hardness in combined setting with 10.4 wt % pea protein isolate.

FIG. 10: Effect of methyl cellulose on the hardening time in combined setting with 10.4 wt % pea protein isolate.

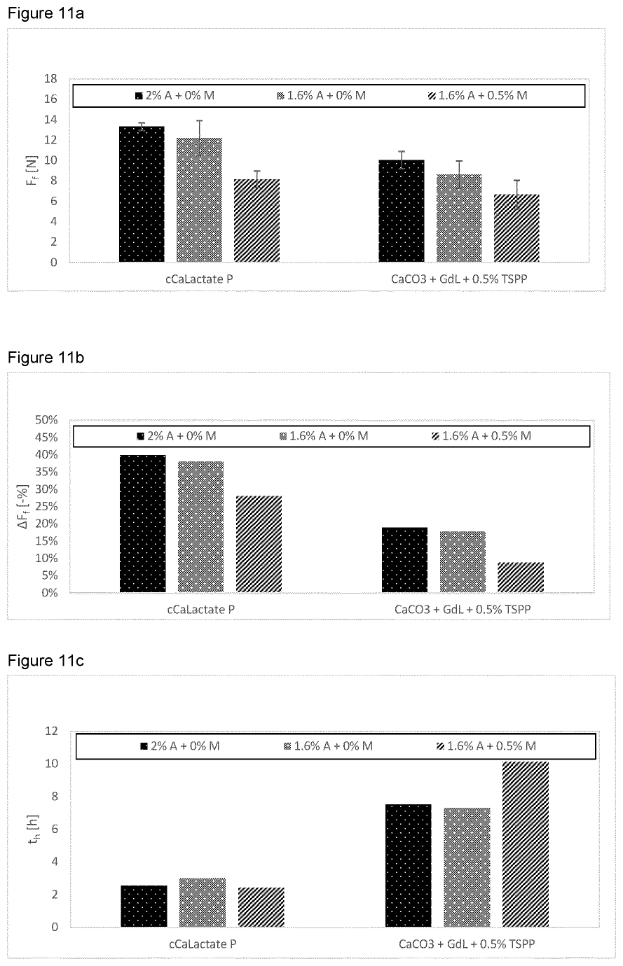

FIG. 11: Effect of methyl cellulose on combined setting with 14 wt % pea protein isolate and 0.5 wt % methyl cellulose: (a) on final hardness, (b) on decrease of final hardness from RT to 70° C. and (c) on hardening time.

In the examples, the following abbreviations are used:
GdL: glucono-delta-lactone
cGdL: coated glucono-delta-lactone
CaCO₃: calcium carbonate
cCaLac coated calcium lactate
MC: methyl cellulose
pbw parts by weight
PPI: pea protein isolate
rpm: revolution per minute
TSPP: tetrasodium pyrophosphate
CaCl₂ calciumchloride-dihydrate

Here and in the following the terms “emulsion” and “malleable mass” are used synonymously.

Here and in the following the terms “particle” and “fibre” are used synonymously.

The following ingredients were used:
Pea protein isolate having a protein content of approx. 85% by weight in dry matter, obtained from Cosucra Groupe Warcoing—Pisane M9 or AGT Foods—Pea Protein 85
Sodium alginate with purity of >90.8% (as sodium alginate), e.g. commercial product of Hewico—Hewigum NA 1
Calcium carbonate: Powder having a maximum particle size Dv50 of 5.8 μm, such as Calmags GmbH— NutriCal CC 800-E
Glucono-delta-lactone: food grade, crystalline powder, e.g. commercial product of Roquette—Glucono-delta-Lactone PL-E575
Coated glucono-delta-lactone (cGdL) having about 30% by weight of a fat coating and a particle size of min. 80%>0.25 mm and min. 90%<1.00 mm, e.g. commercial product of Extrakta Strauss GmbH—Glucono-δ-lactone 7030 P, coated/SG Coated calcium lactate 1 (cCaLac 1 or SF) having about 50% by weight of a coating of hydrogenated sunflower oil and a particle size of max. of 2% retained on USMesh #14 (<1.4 mm), e.g. commercial product of Balchem Encapsulates a version of MeatShure 416 (Encapsulated Calcium Lactate Pentahydrate 50%)
Coated calcium lactate 2 (cCaLac 2 or P) having about 50% by weight of a coating of palm oil and a particle size of max. of 2% retained on USMesh #14 (<1.4 mm), e.g. commercial product of Balchem Encapsulates—MeatShure 416 (Encapsulated
Calcium Lactate Pentahydrate 50%)
Calciumchloride-dihydrate Merck KgaA— Calcium Chloride Dihydrate cryst.
Methyl cellulose, J. Rettenmaier & Söhne GmbH—Vivapur Methyl Cellulose MC A4M
Tetrasodium pyrophosphate (TSPP)— BK Giulini GmbH 71274

pH values were determined by a pHenomenal 1100 L by VWR using a glass electrode.

Conductivity was measured by using an Ahlborn Almemo® 710 measuring instrument in combination with the D7 conductivity sensor FYD 741 LFE01.

Force measurements: Final hardness and hardening time. Compression force was measured with an Imida FCA-DSV-50N-1 with a 20 mm cylindrical stamp.

Calcium was measured from the ash by IC (ion chromatography) with a ThermoFisher Scientific/Dionex ICS-1000 Ion Chromatography System.

Development of New Combined Setup for Hardening

1) Experiment 1: Determining pH development and conductivity with time of an aqueous solution of GdL and CaCO₃ (explaining the mechanism of action of controlled calcium release)

The pH-development and conductivity of two aqueous solutions were measured. In the first solution, 1.6 g GdL were dissolved in 100 ml of deionized water. In the second solution, 1.6 g GdL and 0.45 g of calcium carbonate (CaCO₃) were dissolved (suspended) in 100 ml of deionized water. The pH value and conductivity of the suspension was measured over a period of approx. 50 h.

FIG. 1a) shows the development of pH and conductivity with time of the first solution with only GdL.

FIG. 1b) shows the development of the pH-value and conductivity with time of the second solution containing both GdL and CaCO₃.

FIG. 1c) shows the difference of the two conductivity curves and the calculated dissolution kinetics.

In FIGS. 1a) to 1c) the following abbreviations are used:
pH=pH-value
t=time
SI=Conductivity
α=dissolution kinetics=chemical dissolution rate

From FIG. 1a it can be seen that the pH-value decreases during the first 4 h, afterwards it is constant. The first pH drop from neutral to 3.5 happens quite fast. During the time in which the pH-value drops, hydrolysis of GdL takes place. Simultaneously the conductivity in the solution increases due to the release of the H⁺ ions.

From FIG. 1b it can be seen that the pH value during the first 4 h is much higher compared to only GdL (FIG. 1a). This is due to the buffering induced by dissolved carbonate ions. They bind hydrogen ions and form bicarbonate and carbonic acid, followed by a dissociation into CO₂ and water. Like that the pH value is initially around pH 6.5 instead of pH 3.5 without carbonate. When the dissolution of calcium carbonate is completed after around 5 h, the buffering stops and the pH value drops to pH 5.

From FIG. 1b it can be seen that the development of the conductivity is quite similar to the one in FIG. 1a, but its value is higher. The difference of the two conductivity curves represents the dissolution kinetics of calcium carbonate, which is shown in FIG. 1c. It confirms that the dissolution of calcium carbonate in water with GdL takes around 5 h.

Emulsion Handling Time

2) Experiment 2: Comparison of handling time of internal setting methods containing different calcium sources and different amounts of TSPP

In the following series of experiments the behavior of the emulsion with the internal hardening components was investigated and no sample shaping was carried out by an upstream CaCl₂) bath.

Eight emulsions (2.1) to (2.8) were prepared by mixing 10.4 parts by weight of pea protein isolate, 2.25 parts by weight of alginate, different calcium sources, a solubility inducing component and/or TSPP as a retarder with 9 parts by weight of canola oil, and water to obtain a protein emulsion. The amount of water was adjusted to obtain 100 parts by weight of the emulsion. Mixing was carried out in a Thermomix TM5 at 20° C. The amount of component d), the retarded calcium salt, was chosen to provide in all emulsions 0.4 parts per weight of elemental calcium resp. calcium ions c(Ca²⁺), i.e. in form of CaCO₃ 1.0 parts per weight, or in form of coated calcium lactate 6.3 parts per weight.

The thus obtained emulsions were kept at 20° C. and stirred from time to time to evaluate the point at which gelation starts and the mass becomes too hard to be further processed, e.g. to be stirred, shaped, pumped or conveyed. The time at which the emulsion loses its malleability is denoted as handling time. After the handling time is reached, the emulsion is deemed too be too hard for further processing, when the emulsion lost its malleability.

The results are shown in FIG. 2 and summarized in table 1. In FIG. 2—which shows the handling time of the malleable mass for different retarded forms of calcium salts, optionally an acid or acid precursor, optionally in the presence of TSPP as a retarder—the following abbreviations are used:
CaCO3+GdL=Emulsion containing CaCO₃ and GdL
CaCO3+cGdL=Emulsion containing CaCO₃ and coated GdL
cCaLac SF=Emulsion containing coated calcium lactate (sunflower oil)
cCaLac P=Emulsion containing coated calcium lactate (palm oil)
Time until emulsion gets hard [min]=t

TABLE 1
18274907.22

| | Calcium source | | Acid source | | | |
|---|---|---|---|---|---|---|
| | | c(Ca²⁺) | | Amount | TSPP | Time* |
| Emulsion# | Type | [pbw] | Type | [pbw] | [pbw] | [min] |
| 2.1 | CaCO₃ | 0.4 | GdL | 3.7 | 0 | 11 |
| 2.2 | CaCO₃ | 0.4 | GdL | 3.7 | 0.01 | 15 |
| 2.3 | CaCO₃ | 0.4 | GdL | 3.7 | 0.5 | 55 |
| 2.4 | CaCO₃ | 0.4 | cGdL | 5.0 | 0 | 33 |
| 2.5 | CaCO₃ | 0.4 | cGdL | 5.0 | 0.01 | 38 |
| 2.6 | CaCO₃ | 0.4 | cGdL | 5.0 | 0.5 | 138 |
| 2.7 | cCaLac1 | 0.4 | — | — | 0 | 63 |
| 2.8 | cCaLac2 | 0.4 | — | — | 0 | 129 |

*Handling time

From the results the following conclusions can be taken: The CaCO₃₋/GdL-system increases firmness very fast resulting in a handling time of just 10-15 minutes. Handling time can be increased to about 60 minutes by adding 0.5 pbw of TSPP. Even much smaller amounts of TSPP show a positive trend. The coating of GdL results in another significant increase of the handling time, around three times higher than without. TSPP again increases the time in which the emulsions can be handled. Accordingly, the longest handling time could be obtained for the coated GdL in combination with 0.5 pbw of TSPP to approx. 140 min. The emulsions with coated calcium lactates—without need to add a phosphate retarder—, by a sufficient coating, provided handling times of 1-2 hours. This allows the conclusion that other acids as pH-active substances (e.g. lactic acid) or salts (e.g. CaCl₂)), if sufficiently coated, would be suitable in the same manner.

3) General protocol of determining the hardening time and final hardness of hardened protein mass combining a short-term diffusion setting with the main internal setting:

3.1 For the following tests a standard recipe of a protein mass, hereinafter referred to as protein emulsion or emulsion or as malleable mass, was used. The emulsion is prepared by mixing 10.4 parts by weight of pea protein isolate, 2.25 parts by weight of alginate, the retarded calcium source, optionally a solubility inducing component and/or TSPP as a retarder with 9 parts by weight of a vegetable oil, e.g. rapeseed oil or canola oil, and water to obtain a protein emulsion. The amount of water was adjusted to obtain 100 parts by weight of the emulsion. Mixing was carried out in a Thermomix TM5 for 3 minutes at either 20° C., if coated materials are used as calcium source or solubility inducing component, and at >70° C. −90° C. in any other case.

3.2 For initial curing, 10 g of the emulsion was placed into a cylindrical tube with 33 mm diameter and covered with 10 g of a 3% by weight aqueous solution of CaCl₂) dihydrate. The emulsion mass was scratched from the cylinder wall, thus allowing the emulsion to be undercut by the solution until a sphere is formed which is cured in the solution for 2-15 minutes at a defined temperature, i.e. at 72° C., if coated materials are used as calcium source or solubility inducing component, and at 20-72° C. in any other case. After this short-term diffusion the spheres are taken out of the solution and allowed to drip and then allowed to harden in the dry. Resulting particles have a diameter of approx. 25 mm. A similar form is required for the force measurements made during the curing process, otherwise the results cannot be compared.

3.3 Then firmness/hardness is assessed by a texture analysis measurement at the selected temperature using the following conditions: 3 spherical particles per experiment, measured 3 to 5 times each, compressed 5 mm.

3.4 The hardness measured after 24 h is assumed to be the final one. For the calculation of the hardening time the development of the hardness over time is evaluated. Between the data points of the first 4 h a linear regression is performed. The time at which the regression reaches the final hardness is called the hardening time.

General Force Curve, Final Hardness and Hardening Time

4) Experiment 4: Comparison of compression force of combining diffusion with internal hardening using calcium carbonate and GdL versus only diffusion hardening

4.1 An emulsion (a) was prepared according to the standard recipe described under 3.1, wherein 1 part by weight of CaCO₃, corresponding to 0.4 parts of calcium; which is equivalent (similar) to concentrations absorbed in a pure diffusion method with a 3% CaCl₂) dihydrate-solution, and 3.7 parts by weight of GdL, which is sufficient for complete dissolution of the CaCO₃, were included in the emulsion recipe. The thus obtained emulsion was cured as described above in 3.2.

4.2 As comparison, an emulsion (b) containing 1 part by weight of CaCO₃ but no GdL was prepared according to the standard recipe. The thus obtained emulsion was cured as described above in 3.2.

4.3 As a reference, an emulsion (c) containing neither CaCO₃ nor GdL was prepared according to the standard recipe. The thus obtained emulsion was hardened in a 3 wt % CaCl₂-solution (long-term diffusion setting) for approx. 26 hours.

Each emulsion (a), (b) and (c) contained 10.4 parts by weight of pea protein isolate and 2.25 parts by weight of alginate. The development of hardness, measured as compression force, as described in 3.3, for the different setups—combined internal setting and diffusion setting of emulsions (a) and (b) vs. sole diffusion setting of emulsion (c)—is shown in FIG. 3. In FIG. 3 the following abbreviations are used:
a) CaCO3+GdL=Combined initial diffusion setting and internal hardening with CaCO₃+GdL (according to the invention)
b) CaCO3=Combined initial diffusion setting and internal hardening only with CaCO₃ (not according to the invention)
c) CaCl₂)=Diffusion-based hardening—emulsion in CaCl₂) (not according to the invention) Compression Force TA=F
Time=t

The development of the firmness/hardness of the emulsions (4.1) to (4.3) was determined as described in 3.3. From FIG. 3 the following conclusions can be taken: The emulsion (b) with only CaCO₃ (according to the invention) did not get harder with the time; it thus is proven that the hardening is caused by the dissolution of CaCO₃ induced by GdL. Without such induction, CaCO₃ stays undissolved inside the emulsion and no hardening occurs with time. The emulsion (a) containing both CaCO₃ and GdL (according to the invention) reaches almost the same final hardness as the reference emulsion (c) with only diffusion-based hardening. The most important result is that in contrast to the reference process using emulsion (c) the complete hardening of the process of the present invention, emulsion (a) is achieved within about 5 h, while the reference emulsion (c) required 16 h for achieving final hardness, i.e. until compression force did no longer increase. Accordingly, the combination of internal hardening and diffusion hardening results in a similar product but requires only approximately 30% of the processing time.

Improvements Compared to the Diffusion Setup

5) Experiment 5: Development of internal hardening achieved with different kinds of acids and calcium sources

Six emulsions (5.1) to (5.6) were prepared according to the standard recipe of experiment 3.1, wherein different calcium sources, optionally an acid source and optionally TSPP were included. Their relative amounts are given in the following table 2. Emulsion 5.1 is a reference example, which neither contains a retarded form of a calcium salt nor an acid or acid precursor and was only hardened in a 3 wt % CaCl₂-solution, a long-term diffusion setting for approx. 25 hours. All emulsions contained 10.4 parts by weight of pea protein isolate, 2.25 parts by weight of alginate.

The thus obtained emulsions, except for the reference example 5.1 which was treated as aforementioned, were subjected to a diffusion hardening for 5 min at 20° C. (emulsion 5.2) or for 5 min at 72° C. (emulsions 5.3-5.6) according to the protocol described under 3.2 and thereafter allowed to harden for up to 25 h at 20° C. in a dry environment, i.e. outside the aqueous solution of calcium chloride. During this hardening period samples were taken periodically and the development of the hardening was assessed by measuring the compression force according to the protocol 3.3. Final hardness was determined according to 3.4 above. This hardening time and the final hardness—for different setups of combined setting with different pH-active, solubility-inducing acid sources (optionally in the presence of TSPP) and retarded forms of the calcium salt vs. a reference example of only diffusion setting—are shown in FIGS. 4 and 5 and summarized in table 2.

The amount of component d), the retarded calcium salt, was chosen to provide 0.4 parts per weight of elemental calcium resp. calcium ions c(Ca²⁺) in emulsions 5.2-5.6, i.e. in form of CaCO₃ 1.0 parts per weight, or in form of coated calcium lactate 6.3 parts per weight.

TABLE 2

| | Calcium source | | | | | | |
|---|---|---|---|---|---|---|---|
| | | c(Ca²⁺) | Acid source | | TSPP | Time | FH |
| Emulsion# | Type | [pbw] | Type | [pbw] | [pbw] | [h] ¹⁾ | [N] ²⁾ |
| 5.1 ³⁾ | CaCl₂ | | — | — | — | 15.7 | 17.6 |
| 5.2 | CaCO₃ | 0.4 | GdL | 3.5 | 0.5 | 6.3 | 6 |
| 5.3 | CaCO₃ | 0.4 | cGdL | 5.0 | 0.01 | 6.4 | 10.6 |
| 5.4 | CaCO₃ | 0.4 | cGdL | 5.0 | 0.5 | 5 | 6.3 |
| 5.5 | cCaLac2 (P) | 0.4 | — | — | — | 2.7 | 15.8 |
| 5.6 | cCaLac1 (SF) | 0.4 | — | — | — | 2.3 | 16 |

¹⁾ Time to achieve final hardness
²⁾ Final hardness
³⁾ Reference example (hardened in a 3 wt % CaCl₂-solution - only diffusion setting)

FIG. 4 shows hardening time for different setups of combined setting with different pH-active, solubility-inducing acid sources, optionally in the presence of TSPP, and retarded forms of the calcium salt vs. a reference example of only diffusion setting.

FIG. 5 shows the final hardness for different setups of combined setting with different pH-active, solubility-inducing acid sources, optionally in the presence of TSPP, and retarded forms of the calcium salt vs. a reference example of only diffusion setting.

In FIGS. 4 and 5, the following abbreviations are used:
Hardening time=tₕ
Final Hardness=F_{f}
CaCl₂=Emulsion+CaCl₂-bath (reference)
CaCO₃+GdL+0.5% TSPP=Emulsion containing CaCO₃+GdL+0.5% TSPP
CaCO₃+cGdL+0.01% TSPP=Emulsion containing CaCO₃+coated GdL+0.01% TSPP
CaCO₃+cGdL+0.5% TSPP=Emulsion containing CaCO₃+coated GdL+0.5% TSPP
cCaLac P=Emulsion containing coated Calcium Lactate (palm oil)
cCaLac SF=Emulsion containing coated Calcium Lactate (sunflower oil)

The following observations were made: The combination of CaCO₃ with GdL (coated or non-coated) increases the process speed significantly down to a hardening time of min. 5 h. The amount of TSPP to increase the handling time of the emulsion does not significantly affect the overall hardening time, which is always around 5-6 h.

In this setup final hardness is softer than for the reference example. If more TSPP is added, the overall fraction of free calcium is reduced, and thus the final hardness decreases again. Reducing the amount of TSPP increases the final hardness but does not increase the hardening time. Conversely, if more calcium and acid is added with a given amount of TSPP the handling time will be unchanged but afterwards still a higher final firmness can be achieved.

Compared to this, the particles with coated calcium lactate have almost the same hardness as the reference samples from the diffusion setup and are the best option for the combined setup. There is no significant difference between the two coating options palm oil and sunflower oil. Their addition to the emulsion does not negatively affect the handling properties and there is for a long time (1-2 h) no significant initial gelation. Both coating options allow for reducing the process time significantly from 16 h to 2-2.5 h. The final product has almost the same properties as the reference example.

The new process is not diameter dependent, since hardening takes place at the same time in the whole mass.

Parameter Study to Determine the Possible Composition Range

Experiment 6: Development of internal hardening achieved with different proportions of coated calcium lactate

An experiment was performed in which the fraction of the calcium lactate was varied. The effect on the final hardness and hardening time are shown in FIG. 6.

Twelve emulsions (6.1.1 to 6.6.2 in table 3) were prepared according to the standard recipe described under 3.1, wherein different amounts—from 1.0 to 6.3 parts per weight—of coated calcium lactate 1 or 2 were included. The resulting concentrations of calcium ions in the malleable mass are given in table 3. All emulsions contained 10.4 parts by weight of pea protein isolate, 2.25 parts by weight of alginate.

The thus obtained emulsions were subjected to a diffusion hardening for 5 min. at 72° C. according to the protocol of experiment 3.2 and thereafter allowed to harden for up to 25 h at 20° C. in a dry environment, i.e. outside a curing solution. During this hardening period samples were taken periodically and the development of the hardening was assessed by measuring the compression force according to the protocol 3.3. The influence of the calcium fraction on (a) final hardness and (b) hardening time of fibres/particles produced with 10.4 wt % PPI and 2.25 wt % alginate and hardened with different weight fractions of coated Ca-Lactate (sunflower or palm coating) are shown in FIGS. 6a and 6b.

In FIGS. 6a and 6b the following abbreviations are used:
Final Hardness=F_{f}
Hardening time=tₕ
w_{ca}=weight fraction of calcium [wt %]
cCaLac P=Emulsion+coated Calcium Lactate (palm oil)
cCaLac SF=Emulsion+coated Calcium Lactate (sunflower oil)

TABLE 3

| | Calcium source | |
|---|---|---|
| Emulsion# | Type | c(Ca²⁺) [pbw] |
| 6.1.1 | cCaLac1 SF | 0.07 |
| 6.1.2 | cCaLac2 P | 0.07 |
| 6.2.1 | cCaLac1 SF | 0.13 |
| 6.2.2 | cCaLac2 P | 0.13 |
| 6.3.1 | cCaLac1 SF | 0.20 |
| 6.3.2 | cCaLac2 P | 0.20 |
| 6.4.1 | cCaLac1 SF | 0.30 |
| 6.4.2 | cCaLac2 P | 0.30 |
| 6.5.1 | cCaLac1 SF | 0.36 |
| 6.5.2 | cCaLac2 P | 0.36 |
| 6.6.1 | cCaLac1 SF | 0.40 |
| 6.6.2 | cCaLac2 P | 0.40 |

The following observations were made: The final hardness increases with increasing calcium content. No significant difference can be observed between the two coating options palm and sunflower. In all cases the hardening time to achieve the final hardness was calculated to be 2-3 h.

7) Experiment 7: Development of internal hardening achieved with different protein and alginate levels

Eight emulsions 7.1 to 7.8 were prepared according to the standard recipe of experiment 3.1, wherein different amounts of PPI (10.4 wt % and 14 wt %) were included into the emulsion, with alginate amounts of 1.6 wt % or 2 wt %, and with different calcium sources, i.e. 1.0 wt % calcium carbonate or 6.3 wt % fat coated calcium lactate 2 (cCaLac P). In all cases, the amount of added Ca-ions was 0.4 wt % Ca. Optionally an acid source, i.e. 3.6 wt % of uncoated GdL, and optionally TSPP were also included in emulsions 7.5 to 7.8. Their relative amounts are given in the following table 4.

The thus obtained emulsions were subjected to a diffusion hardening for 5 min at 72° C. (emulsions 7.1 to 7.4) or for 5 min at 20° C. (emulsions 7.5-7.8) according to the protocol described under 3.2 and thereafter allowed to harden for up to 25 h at 20° C. in a dry environment. Final hardness and time for achieving final hardness for different protein and alginate levels was assessed as described in protocol 3.3 and 3.4.

TABLE 4

| | | Calcium source | | | | | | |
|---|---|---|---|---|---|---|---|---|
| Emulsion | | | c(Ca²⁺) | Acid source | | TSPP | PPI | Alginate |
| # | BI # ¹⁾ | Type | [pbw] | Type | [pbw] | [pbw] | [pbw] | [pbw] |
| 7.1 | 1 | cCaLac2 P | 0.4 | — | — | — | 10.4 | 1.6 |
| 7.2 | 2 | cCaLac2 P | 0.4 | — | — | — | 10.4 | 2 |
| 7.3 | 3 | cCaLac2 P | 0.4 | — | — | — | 14.0 | 1.6 |
| 7.4 | 4 | cCaLac2 P | 0.4 | — | — | — | 14.0 | 2 |
| 7.5 | 1 | CaCO₃ | 0.4 | GdL | 3.6 | 0.5 | 10.4 | 1.6 |
| 7.6 | 2 | CaCO₃ | 0.4 | GdL | 3.6 | 0.5 | 10.4 | 2 |
| 7.7 | 3 | CaCO₃ | 0.4 | GdL | 3.6 | 0.5 | 14.0 | 1.6 |
| 7.8 | 4 | CaCO₃ | 0.4 | GdL | 3.6 | 0.5 | 14.0 | 2 |

¹⁾ BI = Bar index in FIGS. 7 and 8

FIG. 7 shows the final hardness of the fibres/particles for the different internal hardening systems at different protein and alginate levels.

FIG. 8 shows the hardening times required for the different internal hardening systems at different protein and alginate levels.

In FIGS. 7 and 8 the following abbreviations are used:
Final Hardness=F_{f}
Hardening time=tₕ
wp+a=different concentrations of protein and alginate
cCaLac P=Emulsion containing coated Calcium Lactate (palm oil)
CaCO3+GdL+0.5% TSPP=Emulsion containing CaCO3+GdL+0.5% TSPP

Bar index #:
1=10.4 wt % PPI, 1.6 wt % alginate
2=10.4 wt % PPI, 2.0 wt % alginate
3=14.0 wt % PPI, 1.6 wt % alginate
4=14.0 wt % PPI, 2.0 wt % alginate

The following observations were made: Both, the protein or the alginate content determined the absolute final hardness, with reduced alginate contents it was lower on both protein levels (FIG. 7). In both cases hardening time was very similar within the same setting system, i.e. relatively independent of the alginate and PPI fraction, but again faster for calcium lactate (FIG. 8).

Influence of Other Thickeners in Reduced Alginate Formulations

8) Experiment 8: Effect of methyl cellulose on internal hardening achieved with different alginate levels and different kinds of acids and calcium sources—Hardening with 10.4 wt % PPI

The hardening with the addition of methyl cellulose in the combined settings was investigated. Ten emulsions (8.1 to 8.10) were prepared according to the standard recipe described under 3.1 with 10.4 pbw of PPI but different levels of alginate, i.e. 2 wt % resp. 1.6 wt %, wherein different calcium sources, optionally an acid source, optionally TSPP and optionally a pre-hydrated MC were included into the emulsion. As calcium source 6.3 wt % coated calcium lactate 2 (cCaLac P) or 1.0 wt % CaCO₃ were used, adding the calcium source mentioned in table 5 at a concentration of 0.4 wt % Ca-ions to the emulsion. As acid source GdL (uncoated) was used. All relative amounts are given in the following table 5.

The MC was included with different amounts of a 2% by weight prehydrated aqueous gel, which was prepared in the Thermomix TM5 by shearing 2 g of methyl cellulose at speed 5 in 98 g of water at 2° C. for 5 min.

The thus obtained emulsions were subjected to a diffusion hardening for 5 min at 72° C. (emulsions 8.1 to 8.5) or for 5 min at 20° C. (emulsions 8.6 to 8.10) according to the protocol described under 3.2 and thereafter allowed to harden for up to 25 h at 20° C. in a dry environment. Final hardness and time for achieving final hardness and the effect of methyl cellulose was assessed for the combined setting with 10.4 wt % PPI and optionally 0, 0.25, 0.5 or 0.8 wt % methyl cellulose as described in protocol 3.3. and 3.4 and are shown in FIGS. 9 and 10.

TABLE 5

| | Calcium source | | | | | | |
|---|---|---|---|---|---|---|---|
| | | c(Ca²⁺)/ | Acid source | | TSPP | Alginate | MC |
| Emulsion# | Type | [pbw] | Type | [pbw] | [pbw] | [pbw] | [pbw] |
| 8.1 | cCaLa2 | 0.4 | — | — | — | 2 | 0 |
| 8.2 | cCaLa2 | 0.4 | — | — | — | 1.6 | 0 |
| 8.3 | cCaLa2 | 0.4 | — | — | — | 1.6 | 0.25 |
| 8.4 | cCaLa2 | 0.4 | — | — | — | 1.6 | 0.5 |
| 8.5 | cCaLa2 | 0.4 | — | — | — | 1.6 | 0.8 |
| 8.6 | CaCO₃ | 0.4 | GdL | 3.6 | 0.5 | 2 | 0 |
| 8.7 | CaCO₃ | 0.4 | GdL | 3.6 | 0.5 | 1.6 | 0 |
| 8.8 | CaCO₃ | 0.4 | GdL | 3.6 | 0.5 | 1.6 | 0.25 |
| 8.9 | CaCO₃ | 0.4 | GdL | 3.6 | 0.5 | 1.6 | 0.5 |
| 8.10 | CaCO₃ | 0.4 | GdL | 3.6 | 0.5 | 1.6 | 0.8 |

FIG. 9 illustrates the effect of methyl cellulose on final hardness of the particles with 10.4 wt % of PPI obtained by combined setting.

FIG. 10 illustrates the effect of methyl cellulose on hardening time of the particles with 10.4 wt % of PPI obtained by combined setting.

In FIGS. 9 and 10 the following abbreviations are used:
Final Hardness=F_{f}
Hardening time=tₕ
cCaLac P=Emulsion containing coated Calcium Lactate (palm oil)
CaCO₃+GdL+0.5% TSPP=Emulsion containing CaCO₃+GdL+0.5% TSPP

The following observations were made: As shown before, since both the protein and the alginate content determine the final hardness, it decreases, if less alginate is used (FIG. 9). Compared to this setting, small fractions of methyl cellulose result in a lower hardness, more methyl cellulose results again in a harder product, e.g. for the setting with coated calcium lactate or with CaCO3+GdL the combination with 0.5 wt % or more methyl cellulose results in a similar or same final hardness and hardening time of the product. The effect on the hardening time is negligible, but hardening time was again faster for calcium lactate (FIG. 10).

9) Experiment 9: Effect of methyl cellulose on internal hardening achieved with different alginate levels and different kinds of acids and calcium sources—Hardening of particles with 14 wt % PPI

Part of the experiment from the previous experiment 8 was repeated with 14 wt % PPI instead of 10.4 wt %. Six emulsions (9.1 to 9.6 in table 6) were prepared different to the standard recipe described under 3.1 in so far that 14 wt % of PPI and different levels of alginate, i.e. 2 wt % resp. 1.6 wt %, were used. Different calcium sources, optionally an acid source, optionally TSPP and optionally a pre-hydrated MC were included into the emulsion. As calcium source 6.3 wt % coated calcium lactate 2 (cCaLac P) or 1.0 wt % CaCO₃ were used corresponding to 0.4 wt % Ca-ions to the emulsion. As an acid source GdL (uncoated) was used. Their relative amounts are given in the following table 6.

Methyl cellulose was prepared by shearing 2 g of methyl cellulose in 98 g of water at 2° C. for 5 min in the Thermomix TM5 at speed 5. In the final emulsion 0.5 wt % methyl cellulose were used.

The thus obtained emulsions were subjected to a diffusion hardening for 5 min at 72° C. (emulsions 9.1 to 9.3) or for 5 min at 20° C. (emulsions 9.4 to 9.6) according to the protocol described under 3.2 and thereafter allowed to harden for up to 25 h at 20° C. in a dry environment. Final hardness (a), the decrease of final hardness from RT to 70° C. (b), time for achieving final hardness (c), and the effect of methyl cellulose was assessed for the combined setting with 14 wt % PPI and optionally 0.5 wt % methyl cellulose as described in protocol 3.3. and 3.4.

TABLE 6

| | Calcium source | | | | | | |
|---|---|---|---|---|---|---|---|
| | | c(Ca²⁺)/ | Acid source | | TSPP | Alginate | MC |
| Emulsion# | Type | [pbw] | Type | [pbw] | [pbw] | [pbw] | [pbw] |
| 9.1 | cCaLa2 | 0.4 | — | — | — | 2 | 0 |
| 9.2 | cCaLa2 | 0.4 | — | — | — | 1.6 | 0 |
| 9.3 | cCaLa2 | 0.4 | — | — | — | 1.6 | 0.5 |
| 9.4 | CaCO₃ | 0.4 | GdL | 3.6 | 0.5 | 2 | 0 |
| 9.5 | CaCO₃ | 0.4 | GdL | 3.6 | 0.5 | 1.6 | 0 |
| 9.6 | CaCO₃ | 0.4 | GdL | 3.6 | 0.5 | 1.6 | 0.5 |

FIG. 11a illustrates the effect of different alginate levels and presence/absence of methyl cellulose on final hardness for the combined setting of example 9 with 14 wt % PPI and two different internal hardening agents.

FIG. 11b illustrates the decrease of final hardness from RT to 70° C. for the combined setting of example 9 with 14 wt % PPI and two different internal hardening agents.

FIG. 11c illustrates the effect of different alginate levels and presence/absence of methyl cellulose on the time for achieving final hardness for the combined setting of example 9 with 14 wt % PPI and two different internal hardening agents.

In FIGS. 11a-11c the following abbreviations are used:
F_{f}=Final Hardness
ΔF_{f}=Decrease in Final Hardness
tₕ=Hardening time
cCaLac P=Emulsion containing coated Calcium Lactate (palm oil)
CaCO₃+GdL+0.5% TSPP=Emulsion containing CaCO₃+GdL+0.5% TSPP

The following observations were made: As for all experiments before the hardness of the particles decreases with decreasing alginate fraction. The addition of 0.5 wt % methyl cellulose decreases the hardness further. Most importantly, the following can be seen from FIG. 11b. Whilst fibres heated to consumption temperature of 70° C. have typically a lower final hardness than those measured at 20° C., the decrease of final hardness after heating is lower if the particles contain methyl cellulose. Thus, methyl cellulose increases the thermal stability of the fibre and thus improves mouthfeel at hot consumption, i.e. the texture is better preserved.

### Production Example 1

Step 1: Into a first mixing vessel equipped with rotating knife blades, like bowl choppers, cutters, Stephan cutters, high speed emulsifiers, in particular those based on the rotor-stator principle, colloid mills and combinations thereof with a blender, 726 g of water having a temperature of 72 to 90° C. were added.

Step 2: 104 g of pea protein isolate, 20 g sodium alginate, 10 g calcium carbonate, 5 g tetrasodium pyrophosphate and 35 g glucono-delta-lactone were added to the water of step 1 with mixing.

Step 3: 100 g of a vegetable fat or oil, such as sunflower oil or rapeseed oil or canola oil, or any other vegetable oil/fat were added to the mixture of step 2 and the total mass was mixed with stirring/shearing at 3000-5000 rpm for 5 minutes while keeping the temperature at 72-90° C. until a stable emulsion was achieved.

Step 4: In a second vessel equipped with a paddle mixer, calcium chloride dihydrate was dissolved in tap water, and optionally ice, at 10-20° C. to obtain 1000 g of a cold 3 wt % aqueous solution calcium chloride dihydrate.

Step 5: The warm malleable mass obtained in step 3 was rapidly pressed through a grid having a mesh-size of 25 mm and directly introduced into the second vessel containing the solution made up in step 4, to obtain strands having a diameter of 25 mm. The grid may be placed above the level of the solution of the calcium salt or below the level, such that the particles are immediately surround by the solution. Instead of a grid, a perforated plate or a diaphragm knife can be used. While the strands can be optionally introduced into another vessel, e.g. by a belt conveyor, the mixture was stirred at 100-1000 rpm and stirring was continued for 5 minutes. The solution was sufficient to cover the particles. During this period a skin formed on the surface of particles, whereby the particles became mechanically stable but did not completely harden.

Step 6: After 5 minutes, the thus obtained particles were taken out of the solution by draining them through a sieve and kept under dry and cold storage at 5° C. for 5-10 hours. Thereby, hardening was completed in a time-delayed hardening manner as the calcium ions contained in the particles are solubilized by the acid source, here glucono-delta-lactone.

### Production Example 2

Step 1: Into a first mixing vessel equipped with rotating knife blades, like bowl choppers, cutters, Stephan cutters, high speed emulsifiers, in particular those based on the rotor-stator principle, colloid mills and combinations thereof with a blender, 681 g of water having a temperature of 20° C. were added.

Step 2: 140 g of pea protein isolate, 16 g sodium alginate and 63 g coated calcium lactate 1 were added to the water of step 1 with mixing.

Step 3: 100 g of a vegetable fat or oil, such as sunflower oil or rapeseed oil or canola oil, or any other vegetable oil/fat were added to the mixture of step 2 and the total mass was mixed with stirring/shearing at 3000-5000 rpm for 5 minutes while keeping the temperature at 20° C. until a stable emulsion was achieved.

Step 4: In a second vessel equipped with a paddle mixer, calcium chloride dihydrate was dissolved in tap water of at least 72° C. to obtain 1000 g of a hot 3 wt % aqueous solution of calcium chloride dihydrate.

Step 5: The cold malleable mass obtained in step 3 was pressed rapidly through a grid having a mesh-size of 25 mm and directly introduced into the second vessel containing the solution made up in step 4, to obtain strands having a diameter of 25 mm. The grid may be placed above the level of the solution of the calcium salt or below the level, such that the particles are immediately surround by the solution. Instead of a grid, a perforated plate or a diaphragm knife can be used. While the strands may be optionally introduced into another vessel, e.g. by a belt conveyor, the mixture was stirred at 100-1000 rpm and stirring was continued for 5 minutes while keeping the temperature at 72° C. The amount of solution was sufficient to cover the particles. During this period a skin formed on the surface of particles, whereby the particles became mechanically stable but did not completely harden.

Step 6: After 5 minutes, the thus obtained particles were taken out of the solution by draining them through a sieve and kept under dry and cold storage at 5° C. for 2-3 hours. Thereby, hardening was completed in a time-delayed hardening manner as the calcium ions contained in the coated calcium lactate particles dissolve, as the coating had been removed by the temperature applied in the previous step 5.

### Production Example 3

Step 1: Into a first mixing vessel equipped with rotating knife blades, like bowl choppers, cutters, Stephan cutters, high speed emulsifiers, in particular those based on the rotor-stator principle, colloid mills and combinations thereof with a blender, 679 g of water having a temperature of 20° C. were added.

Step 2: 180 g of pea protein isolate, 20 g sodium alginate and 31 g coated calcium lactate 2 were added to the water of step 1 with mixing.

Step 3: 90 g of a vegetable fat or oil, such as sunflower oil or rapeseed oil or canola oil, or any other vegetable oil/fat were added to the mixture of step 2 and the total mass was mixed with stirring/shearing at 3000-5000 rpm for 5 minutes while keeping the temperature at 20° C. until a stable emulsion was achieved.

Step 4: In a second vessel equipped with a paddle mixer, calcium chloride dihydrate was dissolved in tap water of at least 72° C. to obtain 1000 g of a hot 3 wt % aqueous solution of calcium chloride dihydrate.

Step 5: The cold malleable mass obtained in step 3 was pressed rapidly through a grid having a mesh-size of 25 mm and directly introduced into the second vessel containing the solution made up in step 4, to obtain strands having a diameter of 25 mm. The grid may be placed above the level of the solution of the calcium salt or below the level, such that the particles are immediately surround by the solution. Instead of a grid, a perforated plate or a diaphragm knife can be used. While the strands may be optionally introduced into another vessel, e.g. by a belt conveyor, the mixture was stirred at 100-1000 rpm and stirring was continued for 5 minutes while keeping the temperature at 72° C. The amount of solution was sufficient to cover the particles. During this period a skin formed on the surface of particles, whereby the particles became mechanically stable but did not completely harden.

Step 6: After 5 minutes, the thus obtained particles were taken out of the solution by draining them through a sieve and kept under dry and cold storage at 5° C. for 2-3 hours. Thereby, hardening was completed in a time-delayed hardening manner as the calcium ions contained in the coated calcium lactate particles dissolve, as the coating had been removed by the temperature applied in the previous step 5.

The particles obtained in step 6 of example 1, example 2 and example 3, respectively, can be processed to an artificial meat product by a process with comprises mixing the particles with binders of non-animal origin, such as hydrocolloids or plant fibres, and/or with herbs and spices, followed by shaping them to the desired shapes e.g. by using moulds or casings. The thus obtained shaped meat substitute products can be portioned, optionally coated, e.g. with batters, breadcrumbs or external seasonings. Then the products are chilled, frozen or pasteurized and packaged for distribution as finished meat substitute products, such as burgers, nuggets, fish fingers, schnitzels, sausages and the like.

1. A process for preparing a vegan edible product from edible non-animal proteins, which comprises
i. providing a malleable mass containing
a) 7 to 20% by weight, based on the total weight of the malleable mass, of an edible protein component a), which is selected from the group consisting of edible vegetable protein materials, edible microbial protein materials and mixtures thereof,
b) 1 to 15% by weight, based on the total weight of the malleable mass, of an edible fat or oil of plant origin,
c) 1 to 3.3% by weight, based on the total weight of the malleable mass, of a water-soluble organic polymeric gelling agent which is capable of being gelled by calcium ions, which is a water-soluble polysaccharide bearing carboxyl groups or a water soluble salt thereof,
d) 0.05 to 0.6% by weight, based on the total weight of the malleable mass and calculated as elemental calcium, of a calcium salt being present in retarded form which releases its calcium ions to the mass in a delayed manner upon heating the malleable mass and/or by lowering the pH value of the malleable mass, and
e) 55 to 90% by weight, based on the total weight of the malleable mass, of water;
ii. comminuting the malleable mass into particles and bringing the particles into contact with an aqueous solution of a calcium salt to achieve a hardening of the particle surface, where during step ii. conditions are applied which effect the release of the calcium ions from the retarded form of the calcium salt, where the release of calcium ions is effected by a controlled increase in the temperature of the malleable mass and/or by a controlled lowering of the pH value of the malleable mass;
iii. separating the aqueous solution from the particles, and
iv. subsequently allowing the particles to harden to achieve their final hardness.

2. The process of claim 1, where the retarded form of the calcium salt is a calcium salt having a solubility in deionized water at 20° C. of less than 2.5 g/L but whose solubility is increased by an acid and where the release of the calcium ions is effected by including an acid or acid precursor suitable for foodstuff into the malleable mass and optionally by heating of the malleable mass during step ii.

3. The process of claim 2, where the calcium salt is selected from the group consisting of calcium sulfate, calcium carbonate and dicalcium phosphate, tricalciumphosphate and dicalciumpyrophosphate.

4. The process of claim 2 or 3, where the acid or acid precursor is included as a coated acid or coated acid precursor and where the release of the calcium ions is effected by heating of the malleable mass to temperatures of at least 50° C. during step ii.

5. The process of any one of claims 2 to 4, where the acid or acid precursor is selected from the group consisting of coated lactic acid, coated ascorbic acid, coated dihydrogen orthophosphate salts, coated pyrophosphate salts, coated gluconic acid, glucono-delta-lactone and coated glucono-delta-lactone.

6. The process of claim 1, where the retarded form of the calcium salt is a coated water soluble calcium salt and where the release is effected by heating the malleable mass during step ii.

7. The process of claim 6, where the coated calcium salt is selected from the group consisting of coated calcium chloride, coated calcium lactate and coated calcium gluconate and where the coated calcium salt is in particular coated calcium lactate.

8. The process of any one of the preceding claims, where the amount of the retarded form of the calcium salt in the malleable mass is such that the weight ratio of calcium ions to the water-soluble organic polymeric gelling agent contained in the malleable mass is in the range of 1:45 to 1:2, where the amount of the water-soluble organic polymeric gelling agent is calculated as its sodium salt.

9. The process of any one of the preceding claims, wherein the water-soluble organic polymeric gelling agent is selected from the water-soluble salts of alginic acid, pectins and mixtures thereof.

10. The process of any one of the preceding claims, where the malleable mass additionally contains methylcellulose in an amount of 0.01 to 1% by weight, based on the total weight of the malleable mass.

11. The process of any one of the preceding claims, where the malleable mass additionally contains an alkalimetal polyphosphate in an amount in the range of 0.01 to 0.5% by weight, based on the total weight of the malleable mass, where the alkalimetal polyphosphate is in particular selected from the group consisting of tetrasodium pyrophosphate, tetrapotassium pyrophosphate, sodium tripolyphosphate, potassium tripolyphosphate and mixtures thereof.

12. The process of any one of the preceding claims, where step ii. comprises the forming of particles from the malleable mass and subsequent introduction of the particles into the aqueous solution of the calcium salt.

13. The process of any one of claims 1 to 11, where step ii. comprises comminuting the malleable mass in the aqueous solution of the calcium salt.

14. The process of any one of the preceding claims, wherein the particles are brought into contact with the aqueous solution of the calcium salt for a contact period in the range of 10 seconds to 60 minutes at a temperature in the range of 0 to 90° C., and even more particular in the range of 0.5 to 15 min., followed by separating the particles from the solution and further curing them outside the solution.

15. A process for preparing an artificial meat product which comprises producing an edible product from edible non-animal proteins by the process of any one of the preceding claims, followed by processing the edible product to an artificial meat product.
